(19) United States
(12) Patent Application Publication
(10) Pub. No.: US 2014/0324472 A1
(43) Pub. Date: Oct. 30, 2014

(54) METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS

(71) Applicants: Conor Delaney, Shaker Heights, OH (US); Jonah Stulberg, Cleveland, OH (US); James Evans, Cleveland Heights, OH (US)

(72) Inventors: Conor Delaney, Shaker Heights, OH (US); Jonah Stulberg, Cleveland, OH (US); James Evans, Cleveland Heights, OH (US)

(73) Assignee: UNIVERSITY HOSPITALS OF CLEVELAND, Cleveland, OH (US)

(21) Appl. No.: 14/326,092

(22) Filed: Jul. 8, 2014

Related U.S. Application Data
(63) Continuation-in-part of application No. 13/985,279, filed on Aug. 13, 2013.
(60) Provisional application No. 61/443,853, filed on Feb. 17, 2011.

(51) Int. Cl. G06F 19/00

(52) U.S. Cl. CPC G06F 19/322
USPC 705/3

(57) ABSTRACT

Systems and methods that facilitate extraction and analysis of patient encounters from one or more healthcare related information systems are provided. In an aspect, a system includes a reception component configured to receive information from a plurality of sources regarding courses of care of a plurality of patients, including information identifying activities associated with the courses of care, timing of the activities, resources associated with the activities, and caregiver personal associated with the activities. The system further includes an indexing component configured to generate an index that relates aspects of the information, a filter component configured to employ the index to identify a subset of the information related to a subset of the courses of care for patients associated with a similar medical condition, and an analysis component configured to compare aspects of the subset of the information to identify variance in the subset of the courses of care.

### PRIORITY CLAIM

This application is a continuation-in-part of U.S. patent application Ser. No. 13/985,279, filed on Aug. 13, 2013, entitled “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS,” which is the National Stage of International Application No. PCT/US2012/025421 filed 16 Feb. 2012 entitled “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS,” and claims priority to U.S. provisional patent application Ser. No. 61/443,853 filed 17 Feb. 2011. The entireties of these applications are incorporated herein by reference.

### TECHNICAL FIELD

The present disclosure is directed to health information systems, and in particularly to methods and systems for extraction and analysis of patient encounters from one or more healthcare related information systems.

### BACKGROUND

Healthcare organizations, such as hospitals and clinics, have at their disposal vast amounts of data through the utilization of a number of healthcare information systems, e.g., for billing, administration, resource scheduling and documentation, patient records, etc. Given that such healthcare organizations face strong pressures to reduce costs while increasing the quality of services delivered, analysis of such available data can lead to greater efficiency, better decision-making, improved patient care, and lower costs. However, the challenge is being able to extract relevant knowledge from such data which can help in the decision-making process.

### BRIEF DESCRIPTION OF THE DRAWINGS

Numerous aspects, embodiments, objects and advantages of the disclosed subject matter will be apparent upon consideration of the following detailed description, taken in conjunction with the accompanying drawings, in which like reference characters refer to like parts throughout, and in which:

FIG. 1 illustrates an example system for extraction and analysis of patient encounters from one or more healthcare related information systems in accordance with various aspects and embodiments described herein;

FIGS. 2-3 respectively present example indexes or data models in accordance with various aspects and embodiments described herein;

FIG. 4 illustrates another example system for extraction and analysis of patient encounters from one or more healthcare related information systems in accordance with various aspects and embodiments described herein;

FIG. 5 illustrates an example flow diagram for generating and updating a model care plan based in accordance with various aspects and embodiments described herein;

FIG. 6 illustrates another example system for extraction and analysis of patient encounters from one or more healthcare related information systems in accordance with various aspects and embodiments described herein;

FIG. 7 illustrates another example system for extraction and analysis of patient encounters from one or more healthcare related information systems in accordance with various aspects and embodiments described herein;

FIG. 8 presents an example user interface that facilitates interacting with a healthcare management server in accordance with various aspects and embodiments described herein;

FIG. 9 presents another example user interface that facilitates interacting with a healthcare management server in accordance with various aspects and embodiments described herein;

FIG. 10 presents another example user interface that facilitates interacting with a healthcare management server in accordance with various aspects and embodiments described herein;

FIG. 11 presents another example user interface that facilitates interacting with a healthcare management server in accordance with various aspects and embodiments described herein;

FIG. 12 is a flow diagram of an example method for extraction and analysis of patient encounters from one or more healthcare related information systems in accordance with various aspects and embodiments described herein;

FIG. 13 is a flow diagram of another example method for extraction and analysis of patient encounters from one or more healthcare related information systems in accordance with various aspects and embodiments described herein;

FIG. 14 is a flow diagram of another example method for extraction and analysis of patient encounters from one or more healthcare related information systems in accordance with various aspects and embodiments described herein;

FIG. 15 is a schematic block diagram illustrating a suitable operating environment in accordance with various aspects and embodiments.

FIG. 16 is a schematic block diagram of a sample-computing environment in accordance with various aspects and embodiments.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter described in this disclosure relates to systems and methods for extraction and analysis of patient encounters from one or more healthcare related information systems. In an aspect, a system includes a reception component configured to receive information from a plurality of sources regarding courses of care of a plurality of patients, including information identifying activities associated with the courses of care, timing of the activities, resources associated with the activities, and caregiver personnel associated with the activities. The system further includes an indexing component configured to generate an index that relates aspects of the information, a filter component configured to employ the index to identify a subset of the information related to a subset of the courses of care for patients associated with a similar medical condition, and an analysis component configured to compare aspects of the subset of the information to identify variance in the subset of the courses of care.

In another aspect, a method is provided that includes receiving information from a plurality of sources regarding courses of care of a plurality of patients, including information identifying activities associated with the courses of care, timing of the activities, resources associated with the activities, and caregiver personal associated with the activities. The method further includes generating an index that establishes relationships between aspects of the information, employing the index to identify a subset of the information related to a subset of the courses of care for patients associated with a similar medical condition, and comparing aspects of courses of care included in the subset to identify variance between the courses of care included in the subset.

In yet another aspect, a tangible computer-readable storage medium is provided that includes computer-readable instructions that, in response to execution, cause a computing system to perform various operations. These operations include receiving information from a plurality of sources regarding courses of care of a plurality of patients, including information identifying activities associated with the courses of care, timing of the activities, resources associated with the activities, and costs associated with the activities. The operations further include generating an index that establishes relationships between aspects of the information, employing the index to identify a subset of the information related to a subset of the courses of care for patients associated with a similar medical condition, and comparing aspects of courses of care included in the subset to identify variance between the courses of care included in the subset.

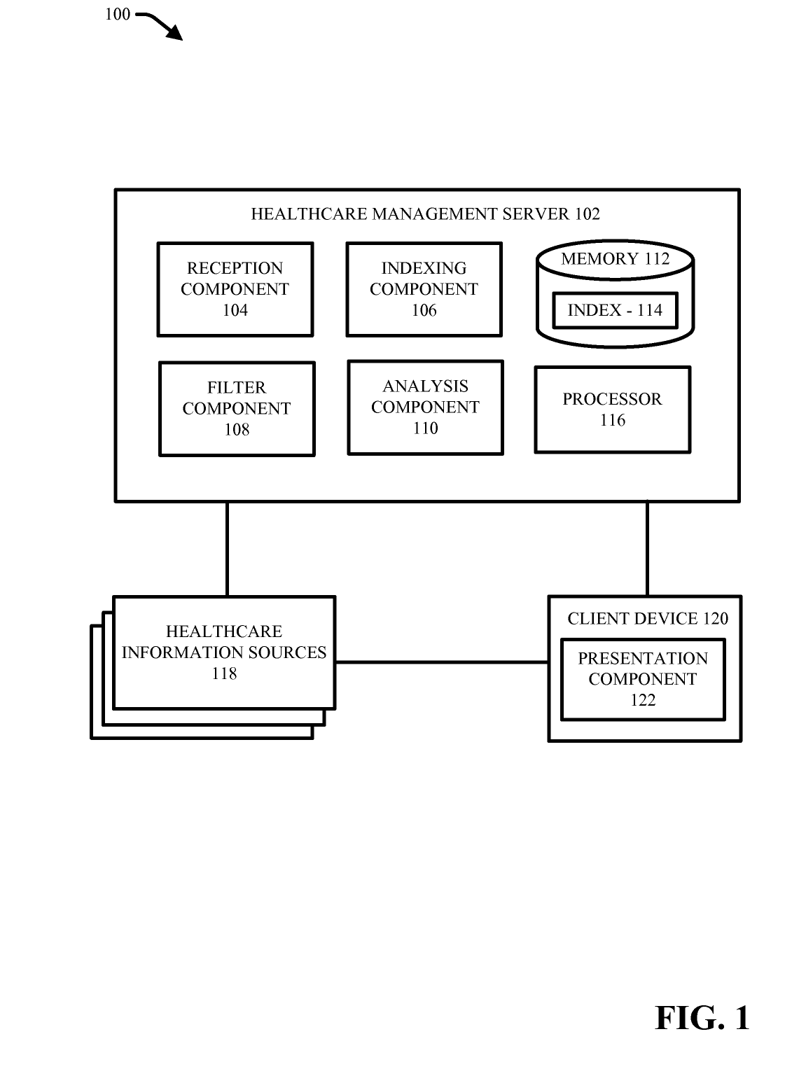

Referring now to the drawings, with reference initially to FIG. 1, presented is diagram of an example system 100 that facilitates extraction and analysis of patient encounters from one or more healthcare related information systems in accordance with various aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

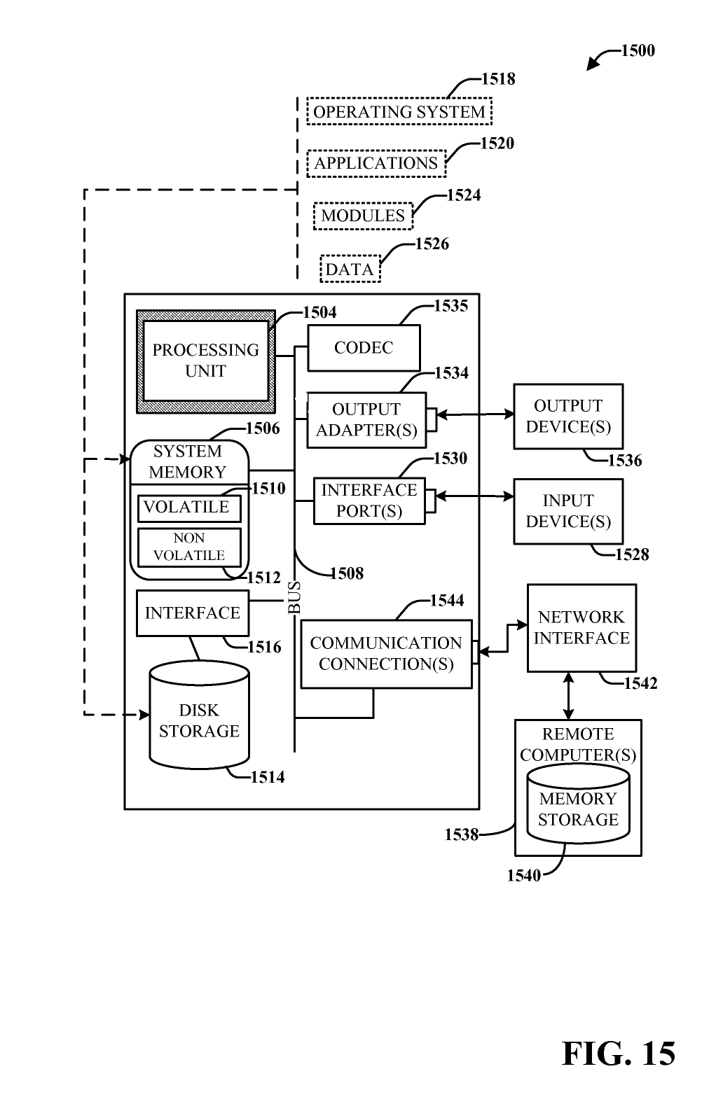

System 100 includes health care management server 102, a plurality of healthcare information sources 118 and one or more client devices 120. Generally, healthcare management server 102, healthcare information sources 118 and client device 120 can include memory (e.g., memory 112) that stores computer executable components and a processor (e.g., processor 116) that executes the computer executable components stored in the memory, examples of which can be found with reference to FIG. 15.

Healthcare management server 102 provides centralized information processing for an integrated healthcare organization or environment. In particular, healthcare management server 102 is configured to receive information from a plurality of different healthcare information sources 118, regarding various aspects of operation of an integrated healthcare organization or environment. These healthcare information sources 118 can include any potential information source that can provide insight regarding all facets of operation and performance of the healthcare organization from the patients and healthcare personnel to physical tools and structures associated with the integrated healthcare organization. For example, healthcare management server 102 can receive information from different departments of a hospital pertaining to courses of care of patients associated therewith, information from electronic medical records for past and present patients of the hospital, billing information from a hospital billing system regarding costs associated with various aspects of patient care and hospital operation, and/or information pertaining to staff scheduling, performance and compensation.

Healthcare management server 102 further processes received information to evaluate and monitor performance of the integrated healthcare organization or environment from various perspectives and at various levels of granularity. For example, healthcare management server 102 can identify variances in courses of care for patients associated with a similar medical condition. For instance, the variances can pertain to quality of care, cost of care, efficiency of care, procedures performed, personnel involved, resources utilized, or timing of various activities associated with the course of care. In another example, healthcare management server 102 enables benchmarking of performance of various departments, employees, physicians, clinical procedure, and any other operational aspect of a healthcare organization at granular level. For instance, healthcare management server 102 can compare performance of a first hospital unit against a second hospital unit as a function of various metrics to identify variances between the units.

Based on the various analytical functions provided by healthcare management server 102, healthcare management server 102 can develop, implement and monitor mechanisms for improving various aspects of operation of a healthcare organization with respect to efficiency, cost, quality of care, and employment satisfaction. At a high level, healthcare management server 102 can function as a great tool to optimize revenue generation, mitigate waste, enhance the patient experience and outcome, and provide for most efficient allocation of resources.

In an aspect, the components of healthcare management server 102 are provided at one or more dedicated computing devices. Users can interface with healthcare management server 102 via the one or more dedicated computing devices and/or via remote client computing devices 120. As used in this disclosure, the terms “content consumer,” “user,” or “participant” refers to a person, entity, system, or combination thereof that employs system 100 (or additional systems described in this disclosure). A client device 120 can include any suitable computing device associated with a user and configured to interact with healthcare management server 102 and/or one or more healthcare information sources 118. For example, client device 120 can include a desktop computer, a laptop computer, a television, an Internet enabled television, a mobile phone, a smartphone, a tablet personal computer (PC), or a personal digital assistant PDA. In an aspect, client device 120 can include presentation component 122 to generate and/or display a graphical user interface (GUI) configured by healthcare management server 102 that facilitates viewing information generated by healthcare management server and interacting with healthcare management server to access and develop reports based on processing capabilities of healthcare management server 102.

In an aspect, presentation component 122 can include an application (e.g., a web browser) for retrieving, presenting and traversing information resources on the World Wide Web. According to this aspect, healthcare management server 102 can provide processed information and interactive data evaluation tools (e.g., for report generating and the like described infra) to users via a website platform that can be accessed using a browser provided on their respective client devices 120. In another aspect, healthcare management server 102 can provide processed information and interactive data evaluation tools (e.g., for report generating and the like described infra) to users via a mobile application platform.

The various components and devices of system 100 can be connected either directly or via one or more networks, (not shown). Such network(s) can include wired and wireless networks, including but not limited to, a cellular network, a wide area network (WAD, e.g., the Internet), a local area network (LAN), or a personal area network (PAN). For example, a client device 120 can communicate with content healthcare management server 102, one or more healthcare information sources 118 and/or another client device (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. It is to be appreciated that although various components of healthcare management server 102 are depicted as co-located on a same device, such implementation is not so limited. For example, one or more components of healthcare management server 102 can be located at another device or associated system, a client device 120, another server, and/or the cloud.

In an aspect, healthcare management server 102 can include reception component 104, indexing component 106, filter component 108 and analysis component 110. Reception component 104 is configured to receive and/or access information from a plurality of different healthcare information sources 118 (e.g., via a network or directly) regarding various aspects of operation of an integrated healthcare organization or environment. In an aspect, the received data can be stored in memory 112 and/or remain stored at the various healthcare information sources 118 and accessed by healthcare management server 102. Indexing component 106 is configured to organize or arrange received/accessed information in the form of an index (e.g., index 114) or data model that relates various aspects of the information (e.g., in a computer readable manner). The index 114 or data model can be stored at healthcare management server 102 and employed thereby as the basis for performance of the various data processing capabilities and functions of healthcare management server 102 described herein.

Healthcare information sources 118 can include any potential information source that can provide insight regarding all facets of operation and performance of an integrated healthcare organization, from the patients and healthcare personnel to the physical tools and structures associated with the integrated healthcare organization. Healthcare information sources 118 can include sources internal and external to the healthcare organization. For example, healthcare information sources 118 can include databases that are internal to a healthcare organization as well as databases associated with other healthcare organizations and national databases shared by many different healthcare organizations.

Healthcare information sources 118 can include information systems, databases, and devices configured to provide information related to operation of a healthcare organization. For example, healthcare information sources 118 can include a healthcare organization's practice management systems (PMS), health information systems (HIS), electronic medical record databases (EMRs), lab systems, medical reference databases, and existing decision support systems. In another example, healthcare information sources 118 can include patient monitoring systems and medical devices configured to sense and provide patient medical information.

Although not a complete listing, the following healthcare information sources 118 can provide useful and relevant information to healthcare management server 102: enterprise systems, revenue cycle/management systems, cost management and information systems, resource scheduling and documentation systems, and the like which are used for e.g., physician billing, organization billing, resource scheduling and documentation, and administration functions.

An example enterprise system can include a system configured to manage aspects of the professional revenue cycle, including scheduling, billing, and claims, such as GE's Healthcare Systems Centricity Enterprise (formerly IDX Carecast) system. For example, an enterprise system (e.g., GE's Healthcare Systems Centricity Enterprise system) can provide healthcare management server 102 with information regarding patients seen by medical providers of the healthcare organization, including patient identifying information, patient demographic information, and patient contact information. For instances where a physician service has been rendered, the enterprise system can further provide information including but not limited to: information identifying the patient, the billing physician, the date of service, the current procedural terminology (CPT) code for the service, the associated diagnoses, the place of service, the referring physician, the professional charge, the primary insurer of record, and/or the payment received and contractual adjustment. CPT codes include a set of medical codes set maintained by the American Medical Association. CPT codes are used to describe and communicate uniform information about medical, surgical, and diagnostic procedures performed on patients among physicians, coders, patients, accreditation organizations, and payers for administrative, financial, and analytical purposes.

An example revenue cycle/management system can include a system configured to capture and provide information to healthcare management server 102 regarding the entire billing process of a healthcare organization. Siemen's Soarian® Financial system is an exemplary revenue cycle/management system which features a contract engine, an enterprise-wide master person index (EMPI), a claims engine, and a denial management engine. In an aspect, a revenue cycle/management system can provide healthcare management server 102 with billing information associated with diagnoses, procedures, and patient accounts. The billing information associated with diagnoses can include records for discharge diagnosis coded within financial system for patients seen by healthcare providers included in the healthcare organization. The information can include data objects identifying a patient name/MRN, ICD-9 diagnosis code, and date of diagnosis. The billing information associated with procedures can include records for procedures performed during a course of care of a patient, including information identifying the patient, the dates of the procedures, and the identity of the medical caregiver (e.g., physician, nurse, nurse practitioner, etc.) that performed the procedures.

Billing information associated with patient records can include an account number for a patient that represents a course of care for the patients. For example, an account number can represent a single inpatient stay, or a cluster of related outpatient visits. In one embodiment, financial information extracted from cost management/information (discussed hereafter) is used to identify a course of care of a patient and a length of stay of the patient at a hospital (or other medical institution) where the patient was admitted in association with the course of care. In an aspect, billing information for a patient record can include information identifying the patient, information on admission and discharge dates, admitting provider, discharging provider, primary care physician, referring physician, and the like.

An example cost management/information system can include a system configured to provide healthcare management server 102 with strategic planning, product line budgeting, cost accounting, and operational and capital budgeting of the healthcare organization. One example, cost management information system is the Eclipsys' Sunrise EPSi™ system. In an aspect, a cost management/information system can provide healthcare management server 102 with data related to technical charges, costs, reimbursement, and projected revenue information for patients cared for by the healthcare organization (e.g., over the course of care of the patients, including in-patient care, out-patient care, or combinations thereof). In an aspect, cost data can be broken into different categories associated with a course of patient care, such as of pharmacy, laboratory, imaging, nursing, etc. For example, reception component 104 can receive data from a cost management information system that identifies a patient, the aggregate technical costs associated with care of the patient, projected revenue associated with care of the patient, reimbursement associated with care of the patient, and information identifying the attending physician associated with care of the patient.

An example, resource scheduling and documentation system that can serve as a healthcare information source 118 can include a system configured to record critical data on all procedures including patient identifying information, time in operating room, time of incision, time of closure, time out of operation room, emergency status, pre-operative/post-operative diagnoses, Anesthesiological Society of America (ASA) Score (reflects patient's short-term risk for mortality), and other data relating to medical procedures. Exemplary recourse scheduling and documentation systems include PICIS' OR Manager System.

Healthcare information sources 118 can also include medical monitoring devices and systems, and implantable and wearable medical devices. For example, a healthcare information source 118 can include a heart monitor or pedometer configured to send sensed information to healthcare management server regarding a patient cared for by the healthcare management server 102. Healthcare information sources can also include users personal devices (e.g., client devices) that can receive, generate and provide information related to operation and performance of a healthcare organization. For example, using a smartphone medical monitoring application, a patient can provide personal medical information to reception component 104. In another example, using a portable device, a healthcare personal can input data for provision to healthcare management server regarding a course of patient care.

In an aspect, reception component 104 can receive information from various healthcare information sources 118 in real-time as it is received or generated at the respective sources. For example, as information is entered into an EMR system for a patient it can be sent to reception component 104. In another example, as vital signs are read from a patient monitoring medical device they can be sent to reception component 104. According to this aspect, the healthcare information source 118 can be configured to push the information to healthcare management server 102 upon entry, receipt or generation at the source. In another aspect, reception component 104 can continuously or periodically (e.g., hourly, daily, weekly, etc.) poll healthcare information sources 118 to identify and extract new information entered, received or generated at the respective healthcare information sources 118. In an aspect, reception component 104 can be configured to receive or extract all data generated or received at a healthcare information source. In another aspect, reception component 104 can be configured to receive or extract a predefined set of data objects from a healthcare information source 118. According to this aspect, these predefined data objects can be defined in memory 112 and reception component 104 can selectively extract the predefined data objects as identified at the respective healthcare information sources 118.

Indexing component 106 is configured to interpret information received by reception component 104 and generate an index 114 or data model that establishes relationships between aspects of the received information. The index or data model can further be stored in memory 112 accessible to healthcare management server 102. In particular, the index can establish relationships between patients, patient medical conditions, patient outcomes, patient quality, aspects of courses of patient care (e.g., diagnoses, inpatient and outpatient length of stay, operations/procedures performed), medical procedures, medical personnel, resources employed, pharmaceuticals employed, medical devices employed, costs, reimbursement, return on investments (ROI), etc. For example, indexing component 106 can identify all information associated with a patient identity (even where the information was received from a plurality of different sources) and generate an index that ties various aspects of the information to the patient identity. It should be appreciated that an index 114 or data model generated by indexing component 106 can be dynamically updated as new information is received by reception component 104.

An index generated by indexing component 106 facilitates comparison and analysis of aspects of an integrated healthcare organization in ways that were previously not performed because the data necessary for such analysis was distributed amongst a plurality of different healthcare information sources and was not aggregated, indexed and related. Most current healthcare analytical applications are restricted by requiring data to be examined against a limited number of predefined dimensions. Healthcare management server 102 removes these restrictions by employing indexing component 106 to map characteristics that were historically either considered mutually exclusive (e.g., diagnosis related group (DRG) code (an institutional billing code), and current procedural terminology (CPT) code (the professional procedure code)) to a common or related baseline feature (e.g., a patient identity, a patient encounter, etc.) and then allowing comparison across multiple dimensions. Much of this information is located in different systems or information sources 118, with some being primarily financial or primarily clinical fields.

Indexing component 106 however can generate an index (e.g., index 114) that relates various aspects of information generated and/or received across a plurality of distributed information sources 118 regarding medical care provided by the healthcare organization and operation of the healthcare organization. For example, indexing component 118 can generate an index that relates the following elements: diagnosis, billing codes, procedure codes, physician (e.g., including primary operating, attending, anesthesiologist, radiologist, etc.), facility, cost (e.g., laboratory costs, radiology costs, pharmacy costs, supply costs, etc.). The index 114 can then be employed by the healthcare management server 102 to perform analysis against the data in an automated and efficient manner to realize how various aspects of the integrated healthcare organization effect one another. For example, with the established index, healthcare information server 102 can enable mapping across various combinations of the elements related via the index (e.g., by analysis component 110, query component 704, report component 706, or modeling component 708) and generate multidimensional comparison indices where prior systems are generally restricted to two-dimensional data comparisons. However, healthcare management server 102 facilitates comparisons via two or more dimensions (e.g., three dimensions, four dimensions, five dimensions, etc.). creating 2 and 3 dimensional data indices for comparison.

For example, healthcare management server 102 enables multi-dimensional views of information through a novel sorting and aggregation approach (e.g., employed by analysis component 110, query component 704, report component 706, or modeling component 708). By using a multi-dimensional selector, a unique population can be generated (for example, filtering physician group and primary procedure). Then, within the application, as many as two more filters can be applied (diagnosis and facility, for example). Hence, healthcare management server 102 can create a four dimensional view of information. The information can be viewed graphically and/or in a report format as processed via report component 706 and rendered via a graphical user interface.

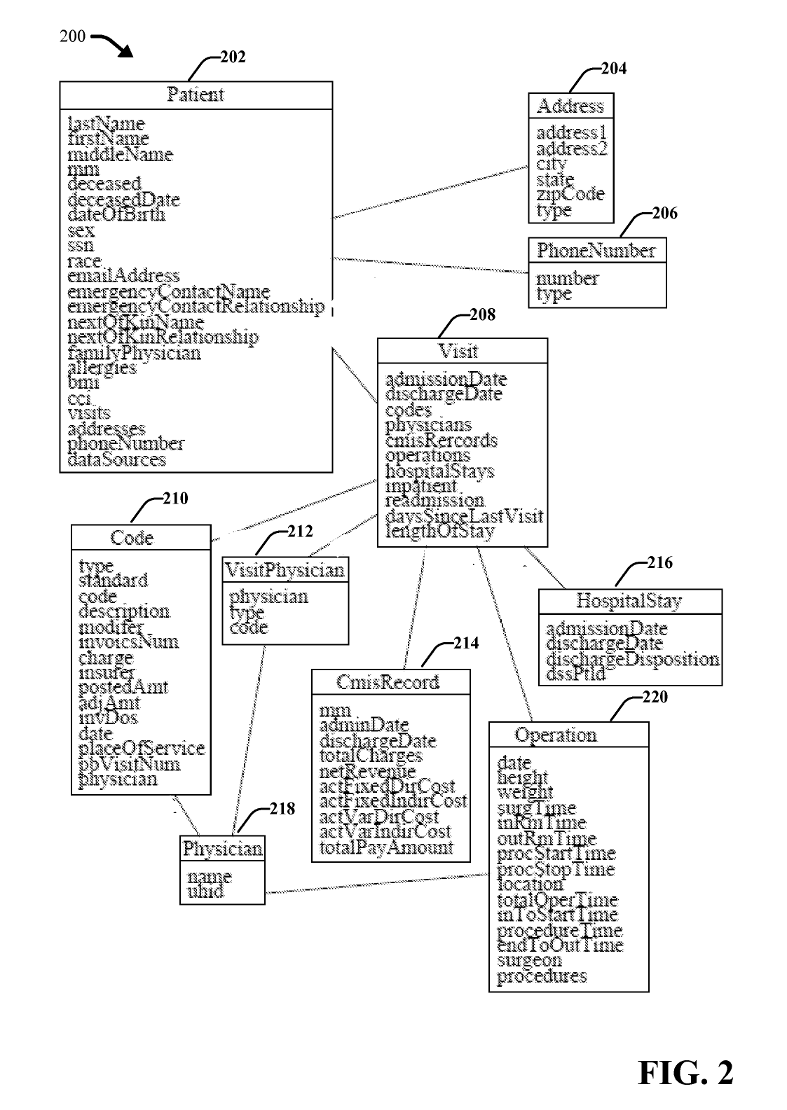

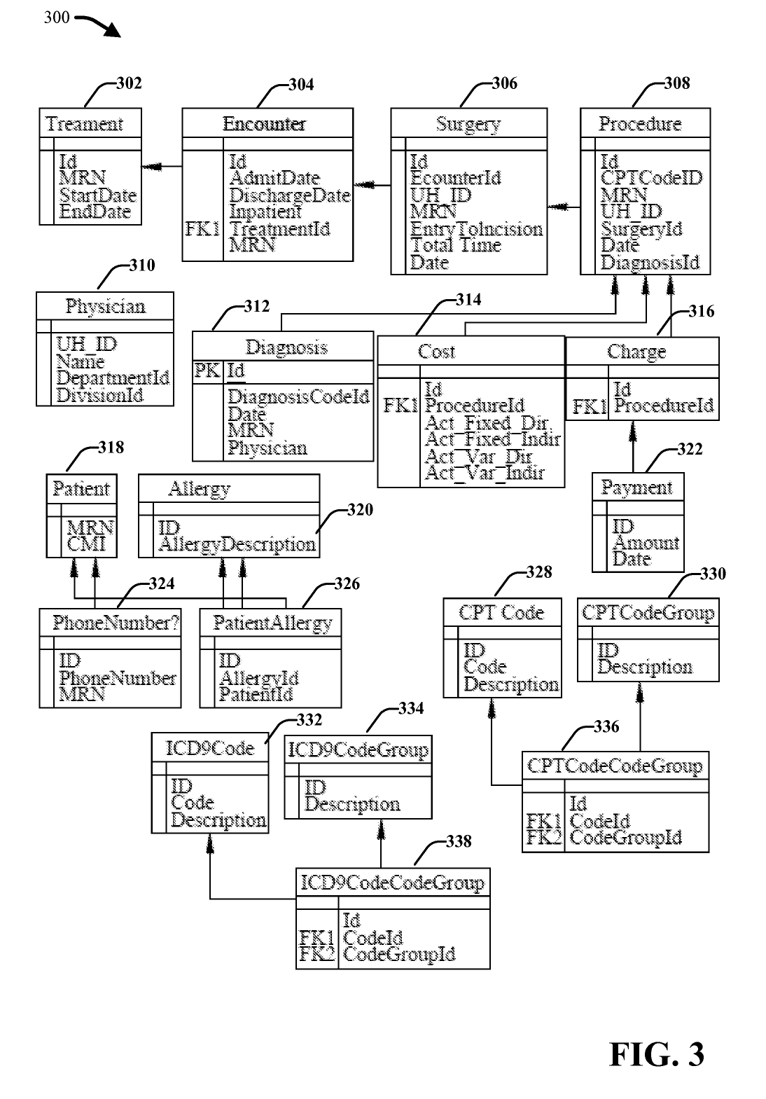

FIGS. 2 and 3 present example indexes 200 and 300 (or data models), respectively, that depict types of information that can be received by healthcare management server 102 and manners in which the information can be organized and arranged. Each of the boxes of the respective indexes represent a different data object or objects containing the fields listed. For example, index 200 includes a plurality of data objects connected via a matrix of various lines that establishes relationships between the data objects. In particular, index 200 includes data object 202 describing information pertaining to a patient, data object 204 describing patient address information, data object 206 listing patient phone number information, data object 208 listing patient visit information, data object 210 including coding information, data object 212 describing information about a physician assisting with the patient visit, data object 214 providing patient record information, data object 216 providing information regarding the patients hospital stay, data object 218 providing information about the physician and data object 220 describing information about a patient operation.

Index 300 includes data object 302 describing information pertaining to a patient treatment, data object 304 describing patient encounter information, data object 306 listing patient surgery information, data object 308 describing patient treatment information 308, data object 310 providing physician information, data object 312 identifying patient diagnosis, data object 314 outlining cost information, data object 316 identifying charges, data object 318 providing patient information, data objects 320 and 326 providing patient allergy information, data object 324 providing patient contact information, data object 322 providing payment information, data objects 328, 330 and 336 providing CPT coding information and data objects 332, 334 and 338 providing ICD9 coding information.

Referring back to FIG. 1, in an exemplary embodiment, reception component 104 is configured to receive information from a plurality of healthcare information sources 118 regarding courses of care of a plurality of patients. For example, reception component 104 can receive information for all patients that receive medical care from a healthcare organization, including information pertaining to what type of care is provided to the respective patients, what medical conditions the care is provided for, and any other information related to the care that facilitate establishment of encounter based longitudinal timelines that track the courses of the care that are provided.

A course of care of a patient (also referred to herein as a patient episode) includes a whole course of care for a patient with respect to a particular medical condition, whether it be for acute treatment or for a chronic disease. The course of care can include all patient encounters (e.g., in-patient and/or out-patient) associated with care of the patient with respect to the particular medical condition. The course of care can begin upon an initial patient visit, condition diagnosis, hospital or (other medical institution admittance), etc., and end after the patient has stopped care (either electively or at the direction of medical caregivers), is released from care, etc. In an aspect, a course of patient care can include readmission or additional treatment related to a prior patient care event or condition.

In an aspect, information received by reception component 104 regarding a course patient care can include but is not limited to: information identifying activities associated with the course of care, timing of the activities, resources associated with the activities, and caregiver personal associated with the activities.

Information identifying activities associated with a course of care can include information identifying any action that was performed in association with the course of care, including but not limited to: patient encounters with medical personnel (e.g., doctor visits, check-ups, therapy sessions, etc.), patient admittance to a hospital (or other medical institution), patient movement/re-location to different sectors of a hospital or medical institution, discharge, medical procedures performed, laboratory tests performed, patient vital signs, changes in medical condition or state, diagnosis, pharmaceuticals provided, other medical aid provided, etc.

Information pertaining to timing of the activities can be employed to generate a longitudinal timeline establishing when respective activities occurred and the duration of the respective activities. For example, reception component 104 can receive information identifying when a patient was admitted to a hospital and total time in the hospital (length of stay). In another example, reception component 104 can receive information identifying when a patient was moved to different parts of the hospital and time of stay at the different parts of the hospital (e.g., in surgery, in the ICU, etc.). In another example, reception component 104 can receive information pertaining to an amount of time that was required to perform a specific procedure and timing of events between different aspects of a surgical routine.

Information pertaining to resources associated with the activities can include medical supplies and equipment employed in association with the activities, such as drugs administered, devices deployed (e.g., pacemakers, batteries, knee implants, etc.), supplies used (e.g., bandages, stitches, stents, braces, etc.), radiology and other imaging machines employed, and usage of other medical machines.

Information pertaining to caregiver personal associated with the activities can include information identifying medical caregivers that performed respective actions associated with the activities (e.g., nurses, doctors, midwives, technicians, etc.) and the extent of their involvement (e.g., with respect to time and effort). This information can also identify who made certain decisions associated with performance of the respective action and activities (e.g., who decided to operate, who decided to administer a drug, who decided to move the patient, who is responsible for a diagnosis, etc.).

In addition, information received by reception component 104 regarding a course patient care can include billing information associated with the various activities that occur throughout the course of care. For example, billing information can include in costs to the healthcare organization for provision of the care in total and with respect to each of the individual activities/aspects of the care (e.g., based on activities performed, timing of the activities, resources employed in association with the activities, personnel employed in association with the activities, etc.), costs to the patient and/or insurer in total and with respect to each of the individual activities/aspects of the care, and profits received in total and with respect to each of the individual activities. Reception component 104 can also receive other information pertaining to a course of patient care, including, patient reflected quality of care, patient outcome associated with the care, patient satisfaction with the care and any other type of measurable metric that can provide insight regarding quality, performance, results and efficiency of a course of care patient care.

In accordance with this embodiment, indexing component 106 can index all data received associated with a course of patient care for a particular condition and establish a timeline for the patient that charts various aspects of the course of care noted above. For example, indexing component 106 can effectively establish a time map for the course of patient care that aligns activities and features of the activities against time. This allows for analysis of all the treatment that is delivered to the patient over the course of care and comparison between the various aspects of the course of patient care with other indexed/charted courses of care for other patients associated with a same similar condition or associated with dissimilar conditions. Comparison yields variance and variance indicates an opportunity for standardization of care, yielding reduction in cost and improvement in quality.

For example, an indexed/charted course of care for a patient creates an interpretable framework for the buildup of costs throughout the course of care. In an aspect, indexing component 106 can break down costs for different periods of time of a course of patient care and categorizes these costs in terms of major operating categories (e.g., room and board, critical care/ICU, pharmacy, medical/surgery supplies, laboratory, radiology, nursing, operation room, anesthesia, blood, etc.). This allows for, the course of care to be evaluated and compared (e.g., via analysis component 110) to other similar or dissimilar procedures either individually, as a clinical group, by physician, by facility or by any other comparative metric available within the data.

Filter component 108 is configured to filter information received by healthcare management server 102 using an index 114 or data model generated by indexing component 106 to generate a subset of the information based on one or more pre-defined metrics. In particular, filter component 108 can filter received information using the index to generate a subset of the information that is relevant to a particular analytic function performed by analysis component 110 or to a particular query request or report request (discussed infra). For instance, where analysis component 110 is configured, (or requested by a user), to perform comparative analytics against aspects of courses of care of a patients associated with a particular medical condition, filter component 108 can employ the index to identify a subset of the received information that is related to the aspects of the courses of care of the patients associated with the particular medical condition. In another example, in response to a request to view a subset of the received data the is related to a particular query metric (e.g., data related to particular patient, a particular physician, a particular, procedure, etc.), filter component identify the subset of the data using the index and generate or extract the subset of the data.

Analysis component 110 is configured to perform a variety of analytical functions using data received by healthcare management server 102 as indexed, organized, or arranged by indexing component 106. In particular, analysis component 110 can act as a centralized intelligence engine that can analyze different aspects of operation and performance of a healthcare organization from a variety or perspectives and levels. For example, analysis component 110 can analyze financial aspects of operation of the healthcare organization, staffing aspects of the healthcare organization, patient care plan and procedural aspects of the healthcare organization, quality/standards of care of the healthcare organization, efficiency aspect of operation of the healthcare organization, etc., to facilitate developing mechanisms to improve or maintain performance of the healthcare organization with respect to these aspects. Analysis component 110 can perform such analysis with respect to individual departments, courses of care, patient groups, staff members, etc., and/or the healthcare organization as a whole.

In an aspect, analysis component 110 is configured to perform comparative analysis between internal aspects of a healthcare organization to identify variances between the different internal facets. For example, analysis component 110 can compare departments of the healthcare organization, procedures performed by the healthcare organization, caregiver personnel (e.g., physicians, nurses, technicians, etc.) of the healthcare organization, courses of care of the healthcare organization, patients of the healthcare organization, clinical cases of the healthcare etc., with respect to performance quality, efficiency, ROI, or any other comparative metric to identify variances between the compared objects. Analysis component 110 can then determine or infer type and nature of variability at the category level (e.g., supports granular analysis of root drivers). For example, analysis component 110 can determine why one department, procedure, physician group, clinical case type, course of care, etc., is more profitable and/or efficient than the other. In another example, analysis component 110 can determine or infer why certain days in the emergency room are associated with better quality of patient care than other days.

Analysis component 110 can also develop a likely linear regression model based on comparison between aspects of departments, procedures, physicians, courses of care, etc., that correlates variances with true cost drivers. Based on cost analysis, analysis component 110 can determine current and potential ROI with respect to capital expenses (e.g., equipment, construction of new facility, construction of new operating room, etc.). In addition, analysis component 110 can analyze a healthcare organization's overall service portfolio (service portfolio optimization) with respect to ROI. For example, analysis component 110 can determine or infer what services are being offered and can be offered at a reasonably profitable margin based on reimbursement rates. Furthermore, in addition to comparative analysis of internal aspects of a healthcare organization, analysis component 110 can compare aspects of the healthcare organization to external systems, organizations and recognized standards. For example, analysis component 110 can provided benchmarking services for a procedure against peer organizations.

In an exemplary embodiment, analysis component 110 is particularly suited for doing comparative effectiveness analysis when there are two (or more) distinct ways of caring for a condition or when a new care initiative or protocol is launched. In particular, analysis component 110 can compare courses of care of patients associated with a same or similar condition to identify variances in the course of care (e.g., with respect to various measurable metrics) and determine or infer root causes of the variances. According to this embodiment, patient conditions can be classified/grouped as being the same or similar based on predefined parameters provided in memory 112. These parameters can define or group conditions as similar based on both metrics related to the condition (e.g., condition severity, factors associated with the condition) and the patient (e.g., patient age, gender, other conditions effecting the patient, etc.). In an aspect, conditions can be classified/or grouped together based on a taxonomy that employs a hierarchical structure wherein a general condition is broken down into one or more sub-conditions based on level of relatedness of specific features of the sub-conditions. For example, patients suffering from general condition A can be subdivided into patients associated with condition A type I, A type II and A type III, etc. According to this example, based on pre-defined parameters (or a requested grouping for the analysis), analysis component 110 can treat all courses of care for patients suffering from condition A as being similar or separate the courses of care for the different types of condition A.

According to this embodiment, analysis component 110 can compare various aspects of a courses of care of a plurality of patients associated with a same or similar condition to identify variances in the courses of care with respect to efficiency, cost (e.g., cost to healthcare organization, cost to patient, ROI in view of reimbursement, etc.) quality of care, outcome of course of care (e.g., did the patient have a successful outcome, did the patient require re-admittance, was the course of care performed according to standardized protocol, etc.), patient satisfaction with course of care, etc. In an aspect, analysis component 110 can particularly compare various aspects of the courses of care related to activities associated with the courses of care, timing of the activities, resources associated with the activities, and caregiver personal associated with the activities, to identify causes of the variance.

For example, analysis component 110 can compare activities respectively performed in association with the courses of care to identify variances in the activities. According to this example, analysis component 110 could identify an activity that was performed in 40% percent of the course of cares with no effect on the efficiency, quality, or outcome of the courses of care while costing a the healthcare organization an excessive margin of cost. In another example, analysis component 110 can compare timing of activities respectively performed in association with the courses of care to identify variances in the timing of the activities. For example, analysis component 110 can identify courses of care where certain procedures took longer to perform or were postponed for performance at a later time in the course of care. Analysis component can further determine or infer an effect of these time variances with respect to efficiency, quality of care, cost, course of care outcome, etc.

In another example, analysis component 110 can compare resources associated with the activities of the courses of care to identify causes of variance in costs associated with performance of the courses of care. For instance, analysis component 110 can lean why some of the course of care cost the healthcare organization more to perform based and usage of certain supplies, devices, machines, etc. In yet another example, analysis component 110 can compare caregiver personal associated with the activities of with the subset of courses of care to identify causes of variance in efficiency, quality of care, cost, etc. For instance, based on comparison of caregiver personnel involved in the respective courses of care, analysis component 110 can learn that a certain nurse or technician's poor cost the healthcare organization money due to lack of efficiency associated with performing a particular activity. In another example, analysis component 110 can learn that some of the courses of care involved an excessive amount of medical staff or involved a high pay grade employee where such an employee's services were unnecessary.

Healthcare management server 102 is particularly helpful with determining or inferring how a healthcare organization can save costs by providing comparative metrics across categories of cost and finding the areas of greatest variability and, therefore, the greatest savings opportunity. In particular, healthcare management server 102 can employ analysis component 102 to measure variability in service delivery and aligns that against cost to prioritize effort. For example, with respect to courses of care of patients associated with a similar medical condition, analysis component 110 can compare aspects of the courses of care with respect to activities performed over the courses of care, timing of the activities, resources associated with the activities, and caregiver personal associated with the activities as a function of cost to identify variances between these different aspects of the courses of care with respect to cost. Analysis component 110 can then determine which sources of variability have the greatest effect on cost.

In an aspect, analysis component 110 is configured to examine three categories of variance when comparing course of patient care (e.g., either for a similar or dissimilar condition). These include time variance, procedural variance and cost variance verses outcome improvement. Time variance reflects amount to time to perform the procedure and time to utilize resources. Procedural variance reflects increase or decreases in supporting procedures or in drug utilization driven by a change in protocol. This generally has the greatest indirect cost influence. Cost variance verse outcome improvement measures variance in cost of performing different activities and procedures during the course of care as a function of outcome differences between the courses of care. For example, in a hospital setting, new procedures are often introduced with significant increase in cost but little or no improvement in outcomes (e.g., no improvement in patient comfort and no measurable quality change). Analysis component 110 serves as good tool to manage anecdotal information that encourages endless innovation without return. It should be appreciated that data for the respective courses of care can be compared in multiple views and from multiple dimensions to determine or infer root causes of cost variability and is not limited to variability by any specific metric.

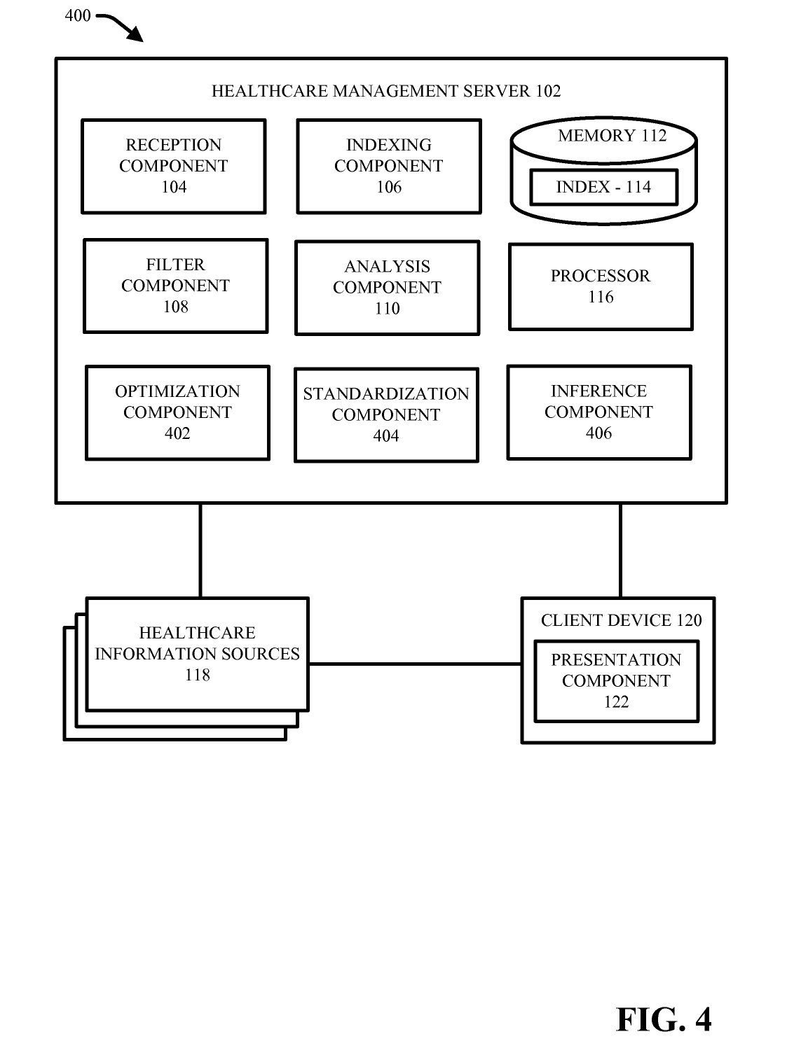

FIG. 4 presents another example system 400 that facilitates extraction and analysis of patient encounters from one or more healthcare related information systems in accordance with various aspects and embodiments described herein. System 400 includes same or similar features and functionalities as system 100 with the addition of optimization component 402, standardization component 404, and inference component 406. Repetitive description of like elements employed in respective embodiments of systems and components described herein are omitted for sake of brevity.

Optimization component 402 is configured to determine or infer mechanisms to optimize performance and operation of a healthcare organization in terms of efficiency, quality/standard of care, cost, course of care outcome, patient satisfaction, employee satisfaction, etc., based on comparative analysis performed by analysis component 110. In particular, optimization component 402 can determine one or more changes to aspects of the healthcare organization to increase or improve efficiency, quality/standard of care, cost, course of care outcome, patient satisfaction, employee satisfaction, service portfolio, etc., based on identification of sources and causes of variance in efficiency, quality/standard of care, cost, course of care outcome, patient satisfaction, employee satisfaction, etc. These changes can consider impact on the entire healthcare organization or a sub-sector of the healthcare organization (e.g., a specific clinical group, a specific procedure, a specific division of the healthcare organization, a group of patients, a staff division, a course of care for a particular condition).

For example, based on analysis regarding variance in efficiency of performance of a medical procedure with respect to number and type of caregivers involved, optimization component 402 can determine or infer a change to number of caregivers required for provision of the medical procedure that will increase quality of care and efficiency of performance of the medical procedure. In another example, based on analysis regarding ROI for a particular medical device or medical service, optimization component 402 can determine or infer that the particular medical device or medical service should be removed from the healthcare organization's service portfolio. In yet another example, based on analysis regarding ROI of a high salaried physician in terms of services provided by the physician, profits associated with services provided by that physician, referrals received based on the physician, and other measurable metrics regarding ROI of the physician, optimization component 402 can determine or infer a change in the physician's salary.

In an exemplary embodiment, based on comparative analysis regarding aspects of a particular course of care, optimization component 402 can determine or infer one or more changes to the course. Optimization component 402, can look at a course of care from various perspectives and aspects to determine what changes can be made to optimize or balance quality/standard of care, cost of care, efficiency, patient satisfaction, employee satisfaction, etc., while maintaining or improving course of care outcome. Optimization component 402 can analyze variances between aspects of the course of care and aspects of other courses of care based on comparison to courses of care for similar or dissimilar conditions and/performed via the healthcare organization or a peer organization. Optimization component 402 can further analyze causes of the variances (as determined or inferred by analysis component 110) to determine or infer changes to the course of care. In addition, optimization component 402 can determine or infer changes to aspects of the course of care based on comparison between the aspects and recognized healthcare standards or benchmarks employed/followed by other healthcare organizations.

In an aspect, as previously described, analysis component can compare a plurality of courses of care for patients associated with a same or similar medical condition to identify variances between the course of care and causes of the variances. According to this aspect, optimization component 402 can determine one or more changes to implement in a future course of care for a patient associated with the same or similar medical condition that minimizes one or more of the variances. For example, analysis component 110 can analyze a plurality of courses of care for a same or similar condition and determine that procedure C is generally only performed when there is an extended delay time (e.g., greater than a threshold time) between performance of routine procedures A and B. In order to reduce performance of procedure C in the future, optimization component 402 can implement a maximum time delay requirement between performance of procedures A and B and/or provide more staff available to perform procedure B.

It should be appreciated that the above optimization example regarding optimization of a course of care is not intended to limit the scope of the subject disclosure. Optimization component 402 can implement a variety of changes to various aspects of a course of care to facilitate optimization thereof, including aspect related to activities associated with the course of care, timing of the activities, resources employed in association with the activities, and medical personnel associated with the activities.

Standardization component 404 is configured to develop a standardized or model care plan for a course of care for a particular condition or group of similar conditions based in part on changes to the course of care determined or inferred by optimization component 402. In particular, standardization component 404 is configured to outline standardized parameters associated with the various aspects of a course of care for a particular condition based in part on comparative analysis performed by analysis component 110 regarding the course of care and optimization determinations and/or inferences determined by optimization component 402 regarding how to improve the course of care (e.g., with respect to balancing and/or enhancing at least one of: efficiency, cost, ROI, quality/standard of care, patient satisfaction, course of care outcome, personnel satisfaction, etc.). The parameters can relate to activities associated with the course of care (e.g., what activities to perform, how to perform them, etc.), timing of the activities (e.g., when to perform them, timing between activities, etc.), resources for the activities (e.g., what supplies, pharmaceuticals and machines to employ, amount of use of resources, etc.), and medical care personnel associated with the activities (e.g., type or specific identify of medical caregivers to perform respective activities, roles of the medical caregivers in association with the activities, number of caregivers associated with performance of a particular activity, etc.). The parameters can also define standards of care, quality of care and costs/expenses allowed in association with provision of the course of care and/or specific activities of the course of care.

In an aspect, standardization component 404 can generate a flow diagram for a model course of care for the condition from start to finish (e.g., initial patient meeting and/or diagnosis with the condition to patient completion of care for the condition). The flow diagram can indicate what activities to perform and when to perform them throughout the course of care. The flow diagram can also include branches for different scenarios that may occur during the course of care (e.g., using decision trees). Information describing other parameters involved in the course of care (e.g., timing between activities, how to perform the activities, what resources to use, what caregiver personal should be involved and their respective roles, etc.) can further be tied to the appropriate blocks/branches of the flow diagram.

Standardization component 604 can also develop standards and regulations regarding various other aspects and operations of a healthcare organization based on various areas for improvement identified by analysis component 110 and various mechanisms to facilitate improvement determined by optimization component 402. For example, standardization component can determine or infer standards/regulations regarding how a particular medical service, procedure, caregiver, or sector of a hospital should operate in terms of efficiency, quality, outcome performance, resource consumption, and costs. In another example, standardization can determine optimal standards/regulations regarding efficiency of various hospital procedures and services, costs associated with those procedures and services, standards of care quality regarding those procedures and service, standards of patient satisfaction regarding those procedures and services, and standards of caregiver performance regarding those procedures and services.

Inference component 406 is configured to provide for or aid in various inferences or determinations associated with aspects of healthcare management server 102. For example inference component 406 can facilitate analysis component 110 with identifying variances between different aspect of operation of a healthcare organization based on comparative analysis. In particular, inference component 406 can facilitate analysis component 110 with identifying causes of variance with respect to efficiency, quality/nature of care, cost, ROI, patient satisfaction, employee satisfaction, etc. in association with analysis of various aspects of operation of the healthcare organization (e.g., courses of care, operation of different sectors, groups of patients, groups of employees, different windows of time, etc.). For example, inference component 406 can infer what aspects of a course of patient care for a particular condition are responsible for increased costs.

In another example, inference component 406 can facilitate optimization component 402 with inferring mechanisms to optimize performance and operation of a healthcare organization in terms of efficiency, quality/standard of care, cost, course of care outcome, patient satisfaction, employee satisfaction, etc., based on comparative analysis performed by analysis component 110. In particular, inference component can facilitate inferring one or more changes to aspects of the healthcare organization to increase or improve efficiency, quality/standard of care, cost, course of care outcome, patient satisfaction, employee satisfaction, service portfolio, etc., based on identification of sources and causes of variance in efficiency, quality/standard of care, cost, course of care outcome, patient satisfaction, employee satisfaction, etc. These changes can consider impact on the entire healthcare organization or a sub-sector of the healthcare organization (e.g., a specific clinical group, a specific procedure, a specific division of the healthcare organization, a group of patients, a staff division, a course of care for a particular condition). Inference component 406 can also facilitate standardization component 404 with inferring standards and regulations to implement regarding how a the healthcare organization as a whole or a particular medical service, procedure, caregiver, or sector of a hospital should perform in terms of efficiency, quality, outcome performance, resource consumption, and costs.

Inference component 406 can have access to the various components of healthcare management server 102, healthcare information sources 118, and/or client device 120 as well as other external systems and sources accessible via a network. In order to provide for or aid in the numerous inferences described herein, inference component 406 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

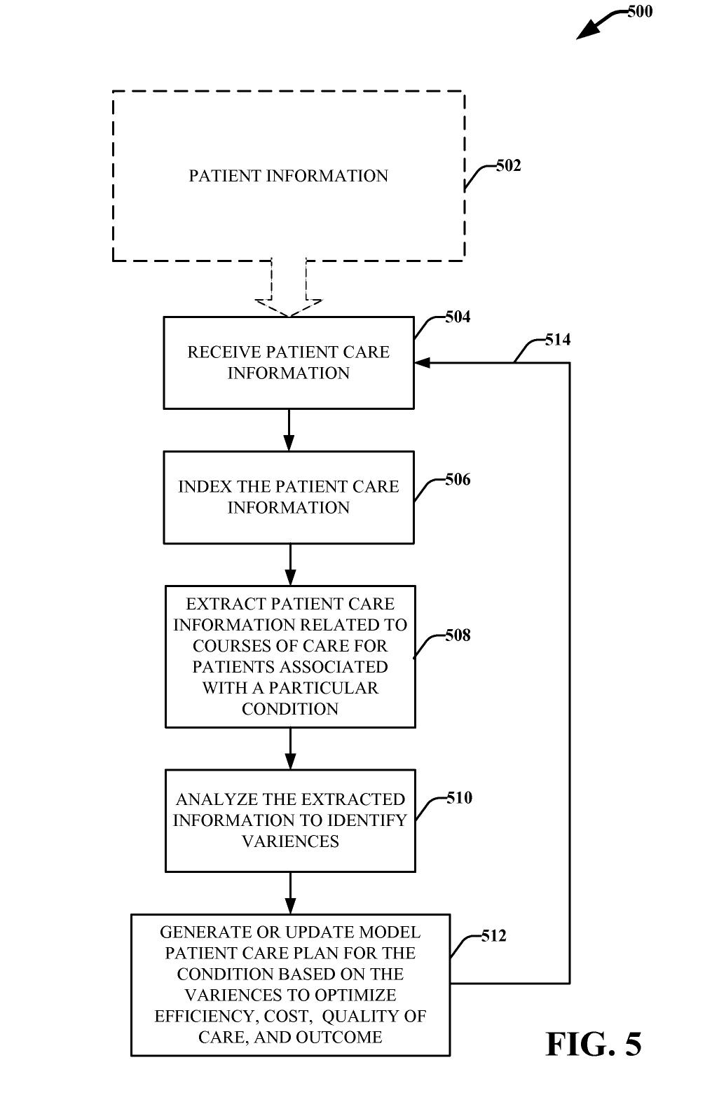

FIG. 5 presents a flow diagram of an example process 500 for developing a standardized care plan for a course of patient care in accordance with aspects and embodiments described herein. Repetitive description of like elements employed in respective embodiments of systems and components described herein are omitted for sake of brevity.

In process 500, at 504, patient care information related to course of patient care is received as input. This patient information can be gathered from a plurality of different sources associated with a healthcare organization. In an aspect, the information is received in real-time as it is generated at the respective sources over the course of patient care. Data input 502 can include various aspects associated with a course of patient care. For example, data input 502 can identify activities associated with courses of patient care, such as what procedures were performed, when they were performed, where they were performed (e.g., hospital, imaging facility, emergency room, homecare, etc.), caregivers involved, etc. Data input 502 can also identify timing associated with the activities. For example, data input 502 can provide a timeline of all activities performed for the courses of patient care from admittance to recovery, including time in days in different parts of the hospital (i.e., in surgery or in ICU), total time in the hospital (length of stay), time in minutes to perform a specific procedure, time between different parts of the surgical routine, etc. Data input 502 can also identify caregivers involved in the activities, what their roles were, their duration and level of involvement, etc. Data input 502 can also identify resources utilized in association with the courses of care, such as drugs administered, devices deployed (pacemakers, batteries, knee implants, etc.), medical equipment used (e.g., imaging machines, laser tools, etc.), supplies used, etc.

As the patient information is received, at 506 the patient information is indexed to establish relationships between aspects of the information. At 508, patient care information related to courses care for patients associated with a particular condition is extracted. For example, a subset of the received data related to courses of care for patients diagnosed with breast cancer can be extracted. At 510, the extracted information is analyzed to identify variances between the course of care. For example, based on comparison of the different course of care, it can be determined that the course of care differ greatly in reported quality of care. The cause of this variance can further be determined or inferred based on deeper comparisons between different aspects of the courses of care (e.g., activities associated with the courses of care, timing of the activities, resources associated with the activities, medical personnel associated with the activities, etc.). At 512, a model patient care plan for the condition is generated or updated (e.g., where previously generated) based on the variances to optimize efficiency, cost, quality of care, and course of care outcome.

In an aspect, process 500 is a dynamic process that is continuously performed over the course of operation of the healthcare organization. For example, as indicated by arrow 514, after a model care plan is generated, new information can be received and pushed through process 500 to provide for dynamic updating of the model care plan base on the new information.

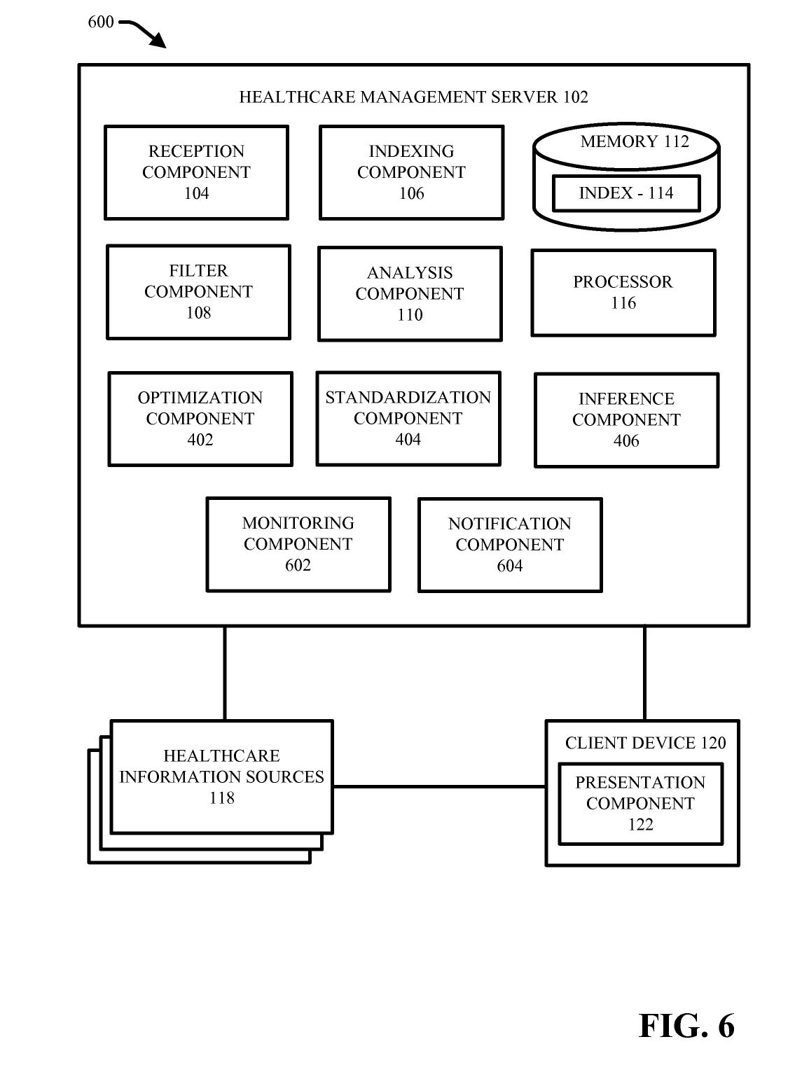

FIG. 6 presents another example system 600 that facilitates extraction and analysis of patient encounters from one or more healthcare related information systems in accordance with various aspects and embodiments described herein. System 600 includes same or similar features and functionalities as system 100 with the addition of monitoring component 602 and notification component 604. Repetitive description of like elements employed in respective embodiments of systems and components described herein are omitted for sake of brevity.

In addition to determining or inferring modifications to aspects of operation of a healthcare organization to implement at a future time based on the various analytical techniques discussed herein (e.g., changes to a course of care for a particular condition, changes in services offered, changes in employee compensation and utilization, etc.) healthcare management server 102 can also facilitate managing operations of a healthcare organization in real-time. In particular, healthcare management server 102 can processes data generated/received at various healthcare information sources 118 as soon as it is available, including concurrent with a patient stay. This facilitates a variety of automated and real-time management opportunities. For example, this facilitates triggering major deviations from an empirically derived standardized care plan (e.g., based on new procedures that haven't been performed in like situations before), and alerting personnel when a cost has been tripped or multiple costs have been rung up in comparison to an empirical baseline (e.g., as determined by optimization component 402 or standardization component 404). In another example, as data is received and processed concurrently with patient care, it be provided to care givers to change care paths, reduce expenses, or improve outcomes while the patient is still in the hospital.

In an aspect, healthcare management server 102 can include monitoring component 602 to monitor operations of a healthcare organization with respect to adherence to various standards and regulations that control the operations. These standards and regulations can include pre-existing standards and regulations and/or standards and regulations determined by optimization component 402 and standardization component 404. In particular, monitoring component 602 can analyze data received from a plurality of different healthcare information sources 118 in real-time or near real-time (as it is received/generated) to identify discrepancies in the data based on pre-determined standards and regulations.

For example, monitoring component 602 can monitor adherence to a standardized care plan for a particular condition over the course of care of a patient for that condition (or a similar condition). According to this example, monitoring component 602 can determine when patient care deviates from the standard care plan beyond an allowable deviation threshold. For instance, monitoring component 602 can determine when certain activities were not performed in accordance with the care plan (e.g., with respect to timing, how to perform, standards of performance, resources allotted for employment in association with the activities, medical personnel requirements in association with performance of the activities, etc.), and when certain activities were skipped. Monitoring component 602 can also assess costs associated with performance of a course of patient care for a condition concurrent with the performance of the course of care in based on cost restrictions defined by a model care plan for the course of care. Monitoring component 602 can thus determine when costs associated with various individual aspects of the course of care and/or cumulative costs up to a current point in the course of care, are not in accord with cost restrictions defined by the model care plan.

In another example, monitoring component 602 can monitor compliance of a healthcare organization as a whole and/or a particular medical service, procedure, caregiver (or caregiver group), and/or sector/unit, with various operational and performance standards/regulations (pre-existing or established by standardization component 404). The operational and performance standards can relate to efficiency, quality, outcome performance, resource consumption, cost (e.g., profit to the healthcare organization, ROI, costs to patient, etc.), patient satisfaction, and employee satisfaction. For example, when examining a particular unit of a hospital (e.g., a cancer division, emergence room, labor unit, etc.), monitoring component 602 can determine when the unit has fallen below desired profit margins (e.g., for the hour, for the day, for the week, etc.). Monitoring component 602 can further monitor or track financial improvement in areas where protocols were defined to facilitate improving ROI and costs. For example, monitoring component 602 can be aligned to regularly test specific hypotheses and to ensure that cost increases are aligned against significant outcomes improvement or have measurable ROI by driving cost reductions in another area. In another example, monitoring component 602 can determine when procedures for a particular unit of a hospital are being performed with unsatisfactory results, efficiency, quality etc. (e.g., by the hour, by the day, by the week, etc.). Monitoring component can further monitor and compare compliance with performance standards between various units/sectors of a healthcare organization in real-time (e.g., at time T1, sector A efficiency level is X and sector B efficiency level is Y).

In an aspect, in association with identifying non-compliance or deviation from a standard or regulation, monitoring component 602 can employ notification component 604 to generate a notification that identifies the nature and degree of the non-compliance or deviation. For example, during the course of patient care, notification component 604 can generate a notification identifying non-compliance with a model care plan for the course of care. For instance, notification component 604 can generate notifications indicating a certain activity was not performed, that a certain drug was not administered, that a certain procedure is being performed inefficiently or that costs accumulated with respect to a current point in care are approaching a threshold cost restriction. In another example, notification component 604 can generate notifications pertaining to certain caregivers, patient groups, services, sectors, or other aspect of a healthcare organization, identifying non-compliance or deviation from a standard or regulation. For example, notification component 604 can generate a notification for a particular unit of a hospital indicating that the efficiency of the nurses has fallen below a standardized performance requirements (e.g., as determined by monitoring component 602).

Notifications generated by notification component 604 can be provided to users (e.g., appropriate medical caregivers of the healthcare organization and/or appropriate personnel of the healthcare organization) in various manners. Notification component 604 can employ various electronic messaging formats to send real-time electronic notifications. For example, notification component 604 can send notification to individual user devices (e.g., client device 120). According to this example, a nurse manager can receive a notification at her personal mobile device regarding the efficiency level of the nurses for her division has fallen below standard or a physician can receive a notification at his personal mobile device regarding the non-compliance of a course of care for one of his patients. In another example, notification component 604 can employ a centralized notification system configured to provide concurrent notifications to one or more related or unrelated users via network based platform.

In an aspect, optimization component 402 can further provide real-time analysis against non-compliances or deviations from standards and regulations to determine or infer mechanisms to correct the non-compliances or deviations in real-time. These mechanisms can further be provided to the appropriate healthcare personnel in real-time so that the non-compliance or deviation can be immediately fixed. These mechanisms can be specific for a current course of care, patient, or aspect of the healthcare organization for which the non-compliance or deviation is based. For example, optimization component 402 can determine mechanisms to improve efficiency or reduce cost in association with a current performance of a course of care where efficiency or cost has fallen below model care plan standards. For instance, optimization component 402 can determine how to change the course of care down the road to reduce costs or improve overall efficiency. According to this example, optimization component 402 may modify the model care plan in real-time for this specific course of care to account for the non-compliance. For example, where a caregiver failed to perform activity A and performance of activity B is dependent on performance of activity A, optimization component can direct the caregiver to perform activity A and then B and further employ additional staff (than allocated in the model care plan) to expedite performance of activity B. According to this aspect, optimization component 402 (and/or inference component 406) can employ historical analysis of past procedures (and other historical data received by healthcare management server 102) to facilitate inferring mechanisms to correct deviations and non-compliances in real-time.

Healthcare management server 102 can further provide additional mechanisms to facilitate real-time performance and operation of a healthcare organization based on received and indexed data. For example, healthcare management server 102 can populate patient records based on past information for the patient and/or historical information for similar patients. In another example, healthcare management server 102 can tailor care plans based on individual patient needs. In yet another example, when a patient care plan is started, healthcare management server 102 can provide the healthcare personnel responsible for performance of the care plan with step by step information identifying how to perform the care plan. Various features of healthcare management server 102 discussed herein are further are exemplified in view of the following scenarios.

A patient is seen in clinic and a decision made for surgery. Information for the patient can be gathered as entered into various system regarding diagnosis, age, status, symptoms, historical information, plan of care, etc. Once clinical information is included, healthcare management server 102 can perform various analytics based on historical data and patient data (e.g., giving risk of complications and likelihood of discharge readmission, etc,). This could be sent real-time to the physician or other healthcare personnel (e.g., using an automatic POSSUM score). Healthcare management server 102 could also populate the EMR (electronic medical record) for the patient with past preferences gather from historical information for the patient.

Prior to surgery, healthcare management server 102 could generate a list of likely instruments and costs to the physician responsible for the surgery. For example, the list could also indicate equipment necessary for the surgery and cost breakdown of each instrument and reusable and disposable item as well as items such as clips and staples, vascular dissecting devices and meshes to prevent adhesions and bleeding. This list can further be provided to the physician and/or healthcare personnel affiliated with the surgery. Following surgery, summary information regarding efficiency, cost, performance and outcome could be generated and provided to medical personnel and/or users responsible for evaluating the surgery. In an aspect, the information could be benchmarked against other hospitals and centers using. Use of robotics and other expensive technology, and its outcomes, could also be reported by healthcare management server 102 before and after surgery (e.g., giving predicted and exact spending). After discharge from the hospital, healthcare management server 102 could plan and report back to the patient and patient caregivers, post-operative instructions regarding optimal medications and care requirements.

In another example scenario, healthcare management server 102 could function as a nurse manager. For example, healthcare management server 102 could compare the number of patients and level of complexity each nurse or physician has, and distribute them to different nursing care units with different levels of supervision based on diagnoses, and intraoperative findings. In yet another example, healthcare management server 102 could determine patient orders and provide this information to medical personnel responsible for care of the patient. For example, healthcare management server 102 could determine when order regarding advancing diet or giving the correct medication depending on stage of care and clinical findings. This could be corrected by CPT code listed for each patient.

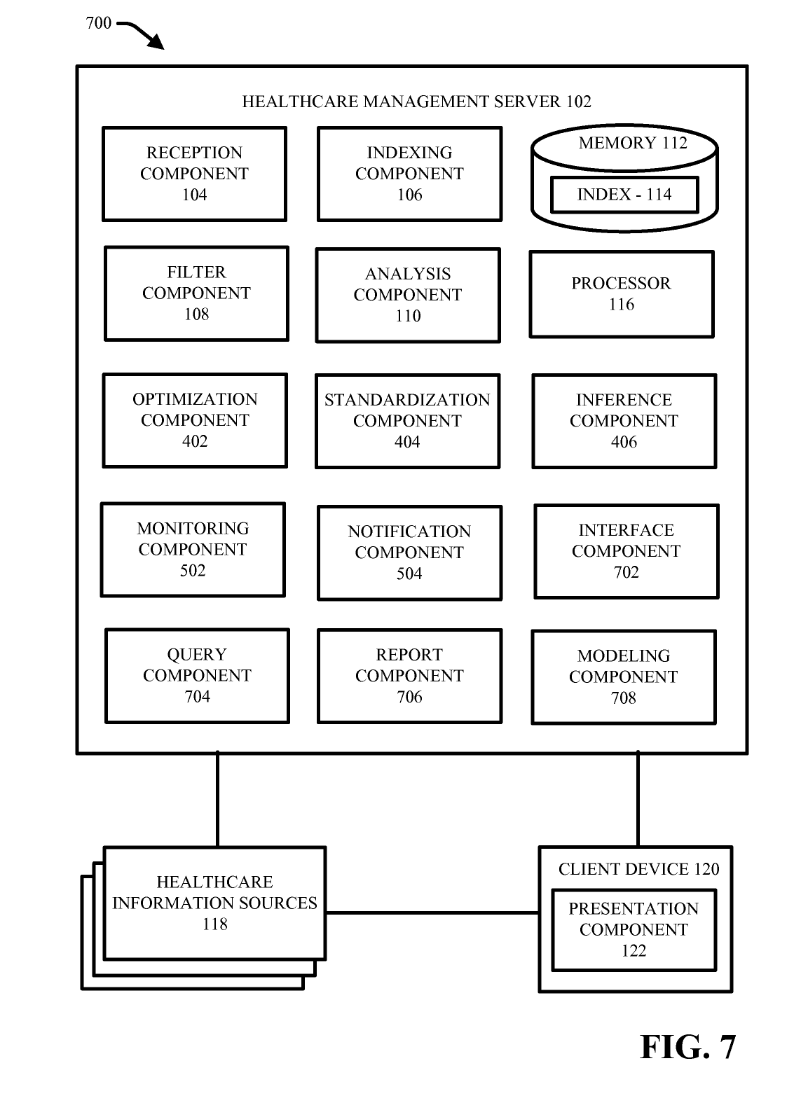

FIG. 7 presents another example system 700 that facilitates extraction and analysis of patient encounters from one or more healthcare related information systems in accordance with various aspects and embodiments described herein. System 700 includes same or similar features and functionalities as system 600 with the addition of interface component 702, query component 704, report component 706 and modeling component 708. Repetitive description of like elements employed in respective embodiments of systems and components described herein are omitted for sake of brevity.

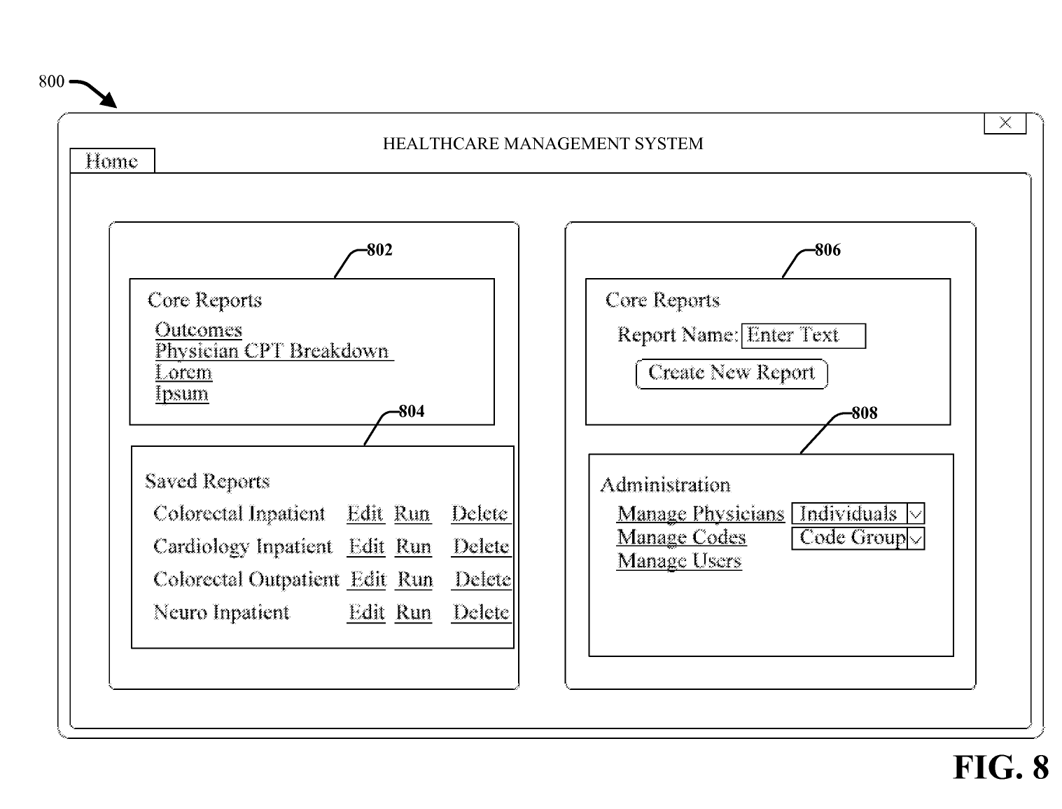

Interface component 702 is configured to generate or configure a user interface that facilitates user interaction with healthcare management server 102. In an aspect, the user interface can display data processed by healthcare management server 102 and facilitate user selection of various data subsets and analytical functions to be applied to the respective data subsets. For example, FIGS. 8-11 present example user interfaces that facilitate report generation and querying functions of healthcare management server 102 in response to user input. FIGS. 8-11 are discussed in greater detail infra. User interfaces generated by interface component 702 can be accessed by users via various interfacing platforms. In an aspect, the interface can be accessed via a network based platform employed by healthcare management server 102 (e.g., a website, a mobile application platform, and the like). In another aspect, the interface can be configured and accessed via resident software provided at the respective client devices 120. According to this aspect, interface component 702, and one or more other components of healthcare management server 102, can be provided at a client device 120. Client devices 120 can render/display an interface generated/configured by interface component 702 using respective presentation components 122.

Query component 704 is configured to enable querying of data received/accessed, indexed and/or processed by healthcare management server 102. For example, system 700 (and the like) provides the capability to search patients, encounters, and groups of encounters by various features such as: procedure, diagnosis, date, provider, division, or department. The data extracts associated with a search query can also provide information related to a group of designated physicians/providers of interest, and to general surgery. Using query component 704, a user can facilitate generating subsets of related data from a wide data set that encompasses data from the variety of sources 118 associated with a healthcare organization. Query component 704 can receive input search terms from a user and generate a search result that includes a subset of data received, indexed, and/or processed by healthcare management server 102 related to the input search terms. For example, a user can input a physician name and procedure type to a query data field of a graphical user interface generated by interface component 702. In response to the received data input, query component 704 can employ an index or data model generated by indexing component to generate a query result that includes information related to the performance of the procedure by the physician.

In an aspect, query component 704 facilitates two types of querying against information received by or accessible to healthcare management server 102 using an index or data model generate by indexing component 106. These include interactive queries and pre-defined queries. Interactive queries include queries based on one or more search terms selected by a user in a freestyle manner (e.g., the user can input any term or term combination). For example, a query result based on criteria associated with a particular patient visit can include including information related to: physicians connected with the visit, procedures performed as part of the visit, operating room utilization or hospital stays associated with the visit, diagnoses, and/or financial information associated with the visit (e.g., aggregate costs, projected revenue, reimbursement, etc.). Pre-defined queries can include queries based on guided selection of a set or subset of pre-defined search terms. For example, a pre-defined query can allow a patient to run a query on pre-defined data subsets, such as patient data, physician data, or encounter data. In an aspect, pre-defined queries can be tied to generation of one or more pre-defined reports by report component 706. In an aspect, data matching search criteria can be exported in .csv format, however, other suitable data formats can be used. For example, query component 704 can also generate a “flat” file containing information for select fields of an index or data model.

Report component 706 is configured to facilitate generating reports based on various subsets of data received, indexed, and/or processed by healthcare management server 102. The reports can take various forms including charts and graphs or text based summaries. Report component 706 can allow a user to combine different subsets of data in various formats and apply functions against the subset of the data to manually analyze the data. For example, report component 706 can generate reports that compare data to facilitate identification of variances, process subsets of data as a function of one another to examine causal relationships for the variances, or view progression of changes in data over time. In another example, report component 706 can provide reports that can help a user answer various questions such “Which care pathways had shortest length of stay in 2008?”, “What proportion of endarterectomy patients are being re-admitted within 30 days of discharge?,” and “Which procedures are being performed cost effectively?” reports can take various forms including charts and graphs to text based summaries.

In an aspect, report component 706 is configured to generate four types of standardized reports including: an outcomes report, an outlier report, a referral report, and a volume report. These reports can include information relating to time in the operating room; the length of a hospital stay; cost information, volume information, referral information, and tracking information.

For example, an outcomes report can relate operating room (OR) data, post operative data and financial data in a spreadsheet or graphical view. The OR data can include columns representing one or more of: surgery volume, entry to incision time, incision to close time, total OR time and OR time outliers. The post operative data can include at least one of: encounter volume, length of stay, length of stay without outliers, APR-DRG, APR-DRG adjusted length of stay, total readmissions, and total length of stay outliers. The financial data can include one or more of: net revenue per admission, hospital cost per admission, hospital cost outliers, contribution margin, contribution margin per admission, contribution margin per patient day, total margin per admit, total margin per patient day, total margin per OR minute.

In another example, an outcomes report that focuses on resource utilization can include both encounter-level and surgery-level metrics. The encounter-level metrics can include one or more of: encounter volume, hospital cost per admit, length of stay, length of stay without outliers, APR-DRG adjusted length of stay, length of stay outliers, number of encounters with length of stay over the CMS geometric mean, and number of readmissions. Surgery-level metrics can include surgery volume, OR time, chargeable surgical supply cost, non-chargeable surgical supply cost, implantable surgical supply cost, biological surgical supply cost and total surgical supply cost.

FIG. 8 presents an example user interface 800 generate by interface component 702 that facilitates generating and viewing reports in association with aspects of report component. For example, interface 800 includes a general core report section 802 that identifies various types of reports capable of generation by report component 702. In an aspect, a user can select one of the types of reports from this section to generate. Interface 800 further include a core report creation section 806 that allows a user to create a new report based on the type of report selected in section 802. In an aspect, queries and reports generated by query and report components, respectively, can be saved under a unique query or report name. A library of useful shared queries/reports could be established and maintained by the system administrator (these could take the place of the current ‘canned’ reports). Accordingly, core report creation section 806 can include a data field wherein the user can enter text to name the report and section 808 provides data fields that facilitates administrative features associated with report generation and access. Interface 800 also includes a saved reports section 804 that identify previously generated and saved reports. Saved reports can be available for viewing, editing, re-running (e.g., based on new or current data), and deleting.

Referring back to FIG. 7, in an aspect, a user interface generated by interface component 702 can include a building queries or reports tab that enables building a query and/or generating a report. The building queries/reports tab can be associated with a set of pre-defined data input fields that facilitate guided creation of a query or report. For example, in association with generation of a query or report, query component 704 and/or report component 706 can receive, via the user interface, input identifying the searching entity, the search criteria the sorting scheme, the aggregating entity, and output elements.

The searching entity can identify what will be searched for (what will a record in the raw result set represent) such as a distinct billable service, a procedure, an encounter, a patient, or a physician (e.g., searchable by provider number, national physician identifier, or name). In an aspect, a user can select the searching entity from a restricted list of pre-defined searching entities via drop down menu of a the user interface.

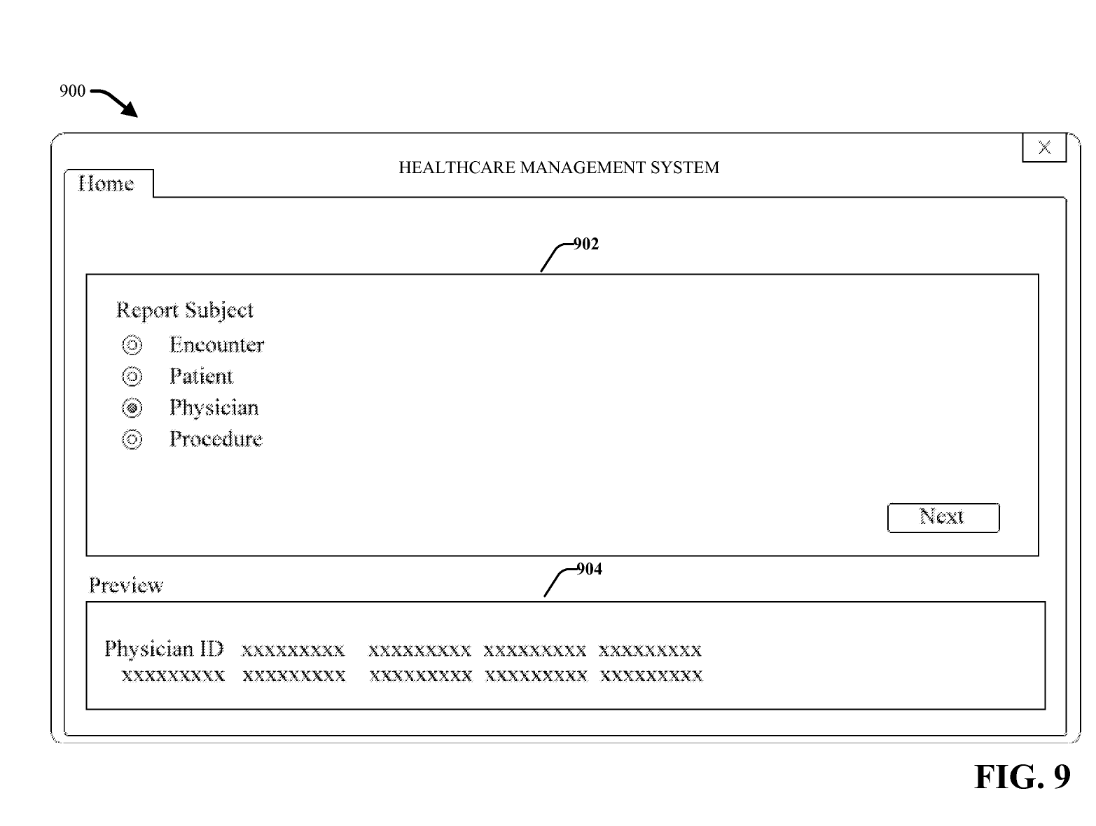

For example, FIG. 9 presents an example user interface 900 that facilitates selecting a searching entity in association with generating a query or report. Interface 900 can include searching entity section 902 that includes a set of searching entities that can be selected to search for in association with a report, including encounter, patient, physician, and procedure. As seen in interface 900, the entity physician is selected. Interface 900 can also include a preview section 904 that displays a subset of information that can be included in a search query result based on the searching entity “physician.”

The search criteria can include a plurality of different pre-defined features associated with the searching entity (e.g., procedure code, diagnosis code, DRG, patient demographics, dates, MRN/patient name, provider, etc.). In an aspect, the options available for selection as search criteria can be dependent on the specified searching entity. For example, the search criteria can include but are not limited to: CPT procedure code, physician, department, division, procedure date, ICD9 procedure code, diagnosis-related group (DRG), admitting/discharging physician, referring physician, admission date, discharge date (before, between, or after), patient date of birth (before, between, or after), patient gender, discharge status, medical record number (MRN), and patient name.

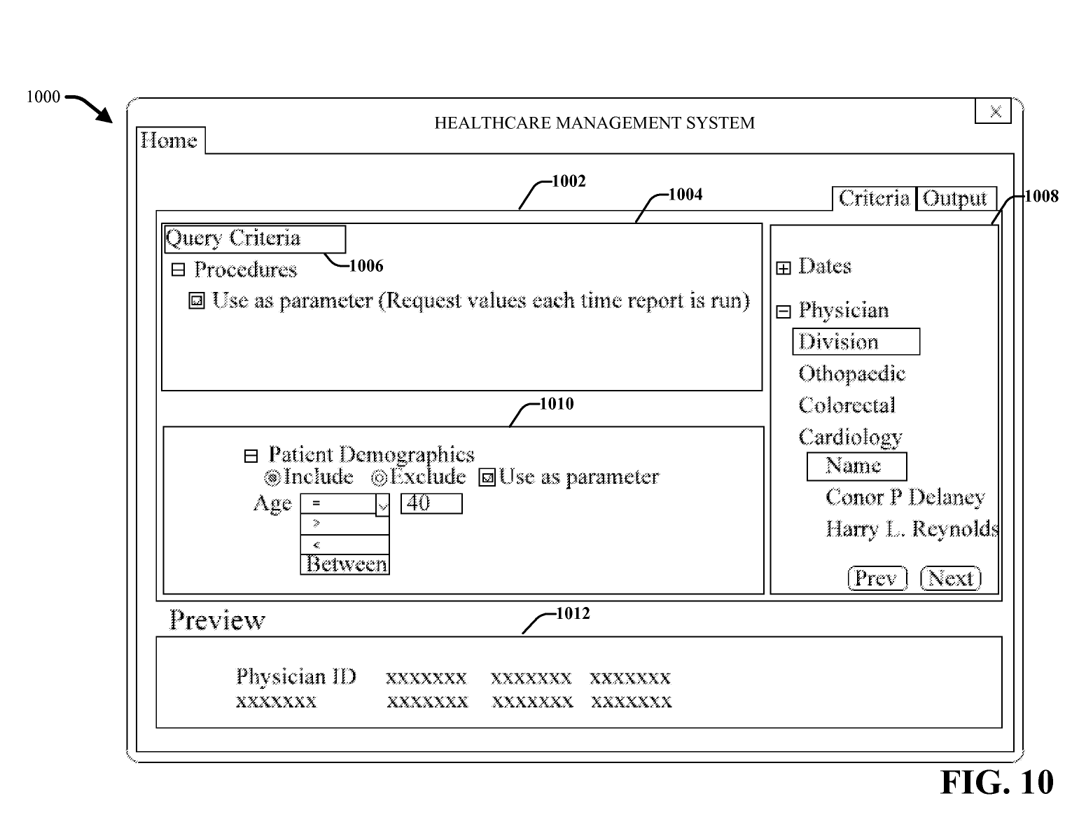

For example, FIG. 10 presents an example user interface 1000 that facilitates selecting search criteria in association with generating a query or report. Interface 1000 can include a criteria section 1002 that includes various pre-defined data input fields with options to select various search criteria. Section 1004 can include a search criteria selection menu 1006 that provides a drop down list of various general categories of search criteria. Although the only criteria displayed here is “procedures,” it should be appreciated that a list of a plurality of different criteria can be displayed in response to selection of the selection menu 1006. Interface 900 further includes additional sections to specify sub-criteria associated with the search or report. For Example, section 1010 enables specification of parameters regarding patient demographics regarding patients to be represented in the query. Section 1008 further provides for narrowing the search criteria by dates and associated physicians (e.g., by division and/or name). Interface 1000 can also include a preview section 1012 that displays a subset of information that can be included in a search query result based on the currently selected criteria.

The sorting scheme specifies how the raw result set should be sorted. For example, results can be sorted in either ascending or descending order by individual column of a spreadsheet report. In some cases, two or more levels of sorting can be applied. For example, results can first be sorted by diagnosis and then sorted by hospital costs, so that within each diagnosis, rows would be sorted from highest hospital cost to lowest hospital cost.

The aggregating entity determines how aggregation of raw results should occur. For example, procedures matching search criteria could be aggregated by encounter (e.g., one line per encounter in which the procedures matching search criteria were performed), patient (e.g., one line per patient who has had a procedure matching criteria), or physician/groups of physicians (e.g., one line per physician who has performed one or more procedures matching search criteria). In an aspect, a result set could be left disaggregated for export as dataset.

The output elements can identify what data elements should be reported and, when results are aggregated, how certain data elements should be summarized (N, sum, mean, median, etc.). In an aspect, output elements can relate to costs associated with the search criteria. For example, a user can request an output include itemized cost data reflecting the search criteria as sorted and aggregated. The output elements can further be specified to request costs in different utilization categories such as diagnostic imaging, laboratory, nursing, operating room, disposable supply and implant use in the operating rooms, etc.

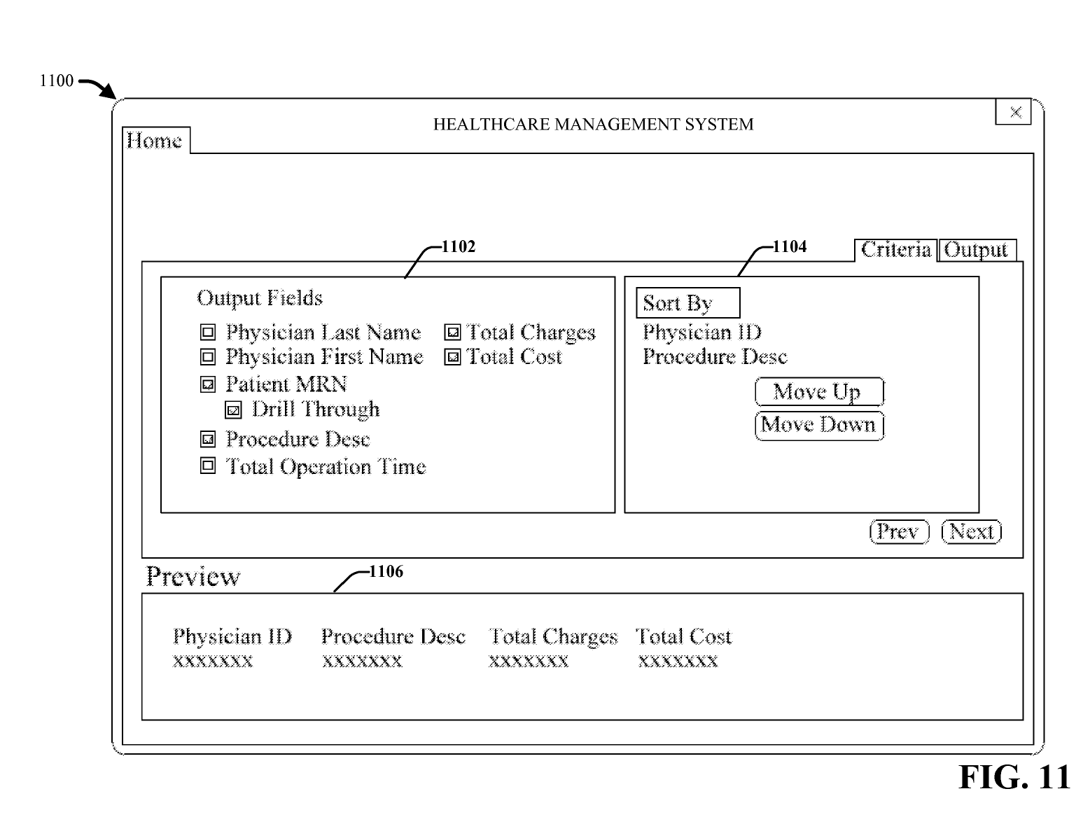

For example, FIG. 11 presents an example user interface 1100 that facilitates selecting output elements in association with generating a query or report. Interface 1100 can include an output fields section 1102 that provides for selecting different output fields to be included in a report (e.g., as the row or column headings in a chart). The precise output elements available for selection would depend on the searching entity and searching criteria specified. In an aspect, when multiple records will be represented in a single output field, continuous variables can be represented by mean and/or median values. In an aspect, dichotomous variables can be represented by proportions and constant variables (e.g. date of birth) can be represented by a constant value. In an aspect, variables with none of these characteristics can be ‘grayed out’ or removed from section 1102 as possible output elements. Interface 1100 further includes a sorting section 1104 that provides for selection of a sorting scheme in association with generation of the report. Interface 1100 can also include a preview section 1106 that displays a preview of a report that will be generated based on the selected output elements.

In an aspect, query/report results can be displayed in another interface or window having various columns with data identified by a heading. Each column can further be sorted in ascending or descending order in response to selection of the column heading. In an aspect, data associated with distinct billable services or procedure can be respectively associate with a link. Upon selection of the link, interface component 702 can generate a new window showing itemized data. The itemized fields featured can be pre-set as description, catalog number, quantity used, quantity wasted, unit cost, total wastage cost, total cost.

Referring back to FIG. 7, modeling component 708 facilitates predicting outcomes regarding future aspects of operation of a healthcare organization using predictive modeling. Predictive modeling is a statistical process by which historical data is analyzed in order to create an algorithm that can be used to infer the likelihood of a future event. Modeling component 708 can employ inference component 406 to perform various inferences associated with predictive modeling analysis. Predictive modeling helps identify the risk of an outcome, based on an in-depth understanding and analysis of what has happened in the past. With the push towards population management, modeling component 708 provides modeling frameworks for process improvement and care management for a health care organization. For example, modeling component 708 can support prediction of the frequency and severity of various patient conditions thus providing room for operational planning. Modeling component 708 can also create financial outcomes models, allowing for “what if” scenario building as process and purchasing initiatives are implemented. In addition, modeling component 708 can provide for comparison of several initiatives and performance against predicted goals.

Modeling component 708 generates foreseeable outcomes and results based on historical data regarding aspects of operation of a healthcare organization and enables interjection of new variables via a computer generated model to test how these new variables will effect a predicted outcome in view of historical data. In particular, modeling component 708 can infer (e.g., using inference component 406), how changes to aspects of a healthcare organization (e.g., determined or inferred by optimization component 402 or a user) will affect various other aspects of operation of the healthcare organization. In an aspect, modeling component 708 can be employed to interject new variables into various reports generated by report component 706 to see how these new variables will potentially effect results. For example, user can apply possible changes to aspects of operation of a healthcare organization (e.g., regarding staffing, purchasing of equipment, adding or removing service offerings, charging schemes, etc.) and test how these changes may affect outcomes in the future based on historical data received, indexed, and processed by healthcare management server 102. Modeling component 708 can also generate reports/charts based on predicted data to enable visualizing potential future outcomes based on predictive modeling techniques. For example, modeling component can 708 can generate a report that indicates how efficiency, costs, patient outcome, quality of care, etc., will change in association with a course of patient care in response to a 75% degree of adherence to a model care plan.

In another aspect, modeling component 708 enables simulation of future scenarios of operation of a healthcare organization, allowing for changing of factors (reimbursement, costs, etc.) to support future “what if” analysis. These simulations can be dynamically displayed/created via an modeling interface generated by interface component 702 that enables changing of variables and generating new predictive reports and charts. For example, modeling component 708 can provide for modeling of care path modifications using active movement/changing of care path features through the a visual user interface and calculation of cost and care benefits accordingly. For example, interface component 702 can generate a user interface that allows users to dynamically change care paths, modeling changes in cost and quality as care path options are changed.

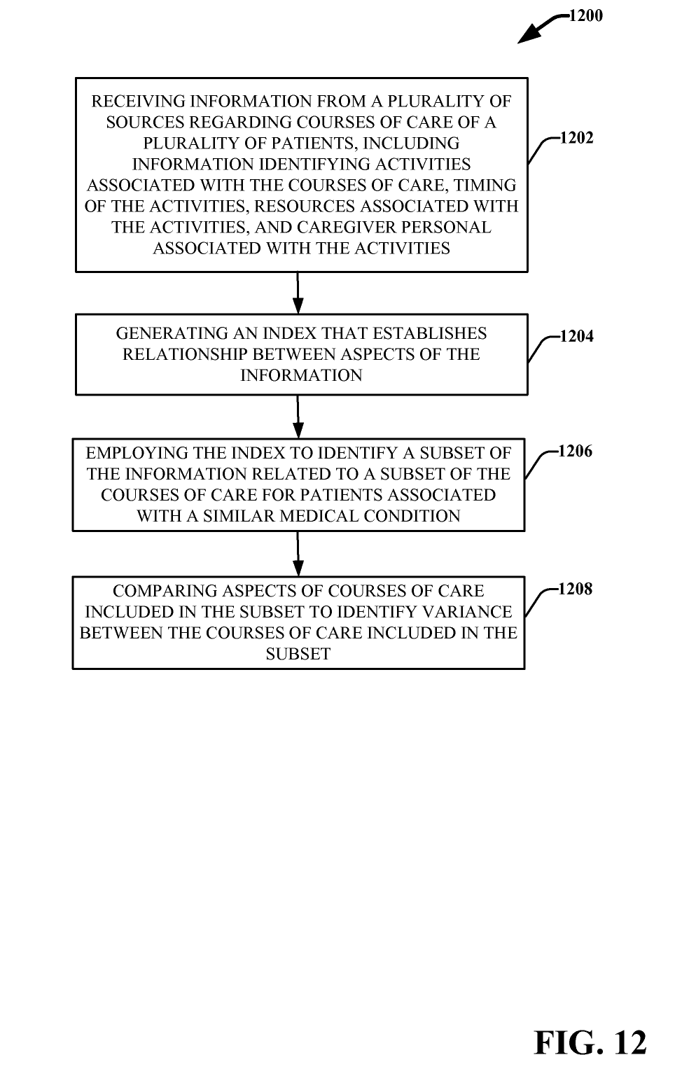

In view of the example systems and/or devices described herein, example methods that can be implemented in accordance with the disclosed subject matter can be further appreciated with reference to flowcharts in FIGS. 12-14. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 12 illustrates a flow chart of an example method 1200 that facilitates extraction and analysis of patient encounters from one or more healthcare related information systems in accordance with various aspects and embodiments described herein. At 1202, information is received (e.g., via reception component 104) from a plurality of sources (e.g., healthcare information sources 118) regarding courses of care of a plurality of patients, including information identifying activities associated with the courses of care, timing of the activities, resources associated with the activities, and caregiver personal associated with the activities. At 1204, an index is generated that establishes relationships between aspects of the information (e.g., via indexing component 106). At 1206, the index is employed to identify a subset of the information related to a subset of the courses of care for patients associated with a similar medical condition (e.g., via filter component 108) and at 1208, aspects of courses of care included in the subset are analyzed to identify variance between the courses of care included in the subset (e.g., via analysis component).

For example, the courses of care can be compared with respect to various measures of efficiency, quality/standard of care, costs (e.g., to the healthcare organization, to the patient/insurer, as a function of profit or ROI, etc.), outcome, patient satisfaction, employee satisfaction, etc., to identify variances between the courses of care. In an aspect, these measures are based on analysis of activities associated with the courses of care, timing of the activities, resources associated with the activities and caregiver personnel associated with the activities. For example, based on analysis and comparison between activities associated with the courses of care, timing of the activities, resources associated with the activities and caregiver personnel associated with the activities, analysis component 110 can determine or infer causes of variance between the courses of care with respect to efficiency, quality/standard of care, costs (e.g., to the healthcare organization, to the patient/insurer, as a function of profit or ROI, etc.), outcome, patient satisfaction, employee satisfaction, etc.

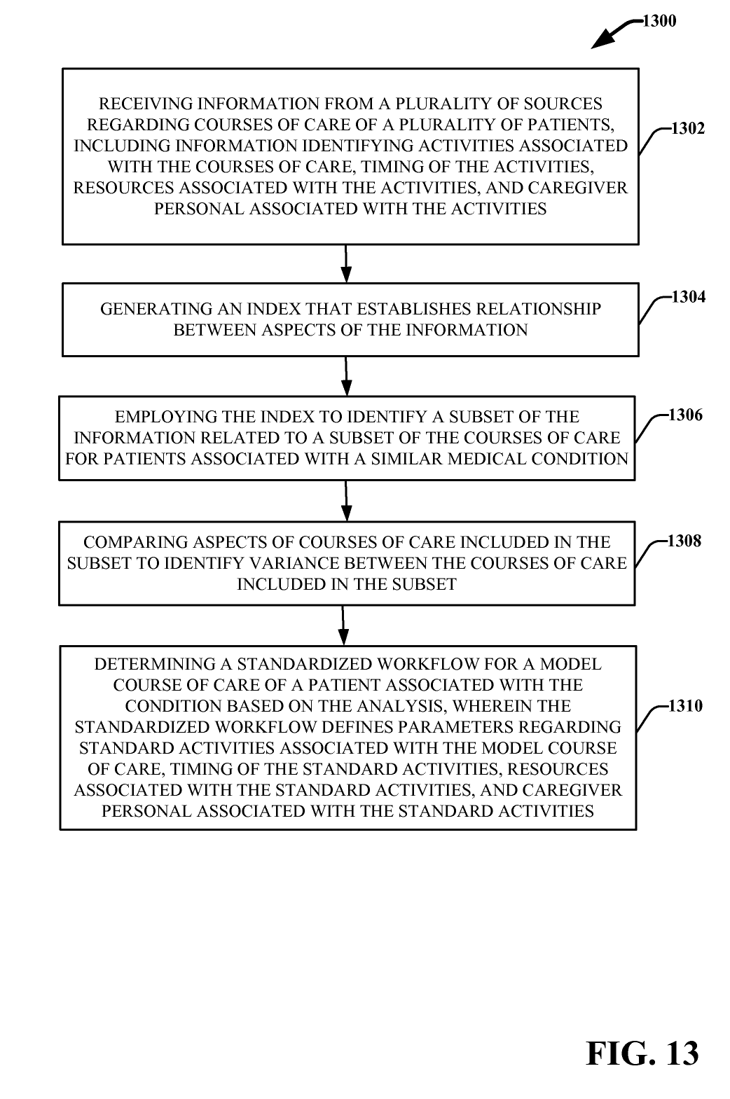

FIG. 13 illustrates a flow chart of another example method 1300 that facilitates extraction and analysis of patient encounters from one or more healthcare related information systems in accordance with various aspects and embodiments described herein. At 1302, information is received (e.g., via reception component 104) from a plurality of sources (e.g., healthcare information sources 118) regarding courses of care of a plurality of patients, including information identifying activities associated with the courses of care, timing of the activities, resources associated with the activities, and caregiver personal associated with the activities. At 1304, an index is generated that establishes relationships between aspects of the information (e.g., via indexing component 106). At 1306, the index is employed to identify a subset of the information related to a subset of the courses of care for patients associated with a similar medical condition (e.g., via filter component 108). At 1308, aspects of courses of care included in the subset are analyzed to identify variance between the courses of care included in the subset (e.g., via analysis component). At 1310, a standardized workflow is determined for a model course of care of a patient associated with the condition based on the analysis, wherein the standardized workflow defines parameters regarding standard activities associated with the model course of care, timing of the standard activities, resources associated with the standard activities, and caregiver personal associated with the standard activities.

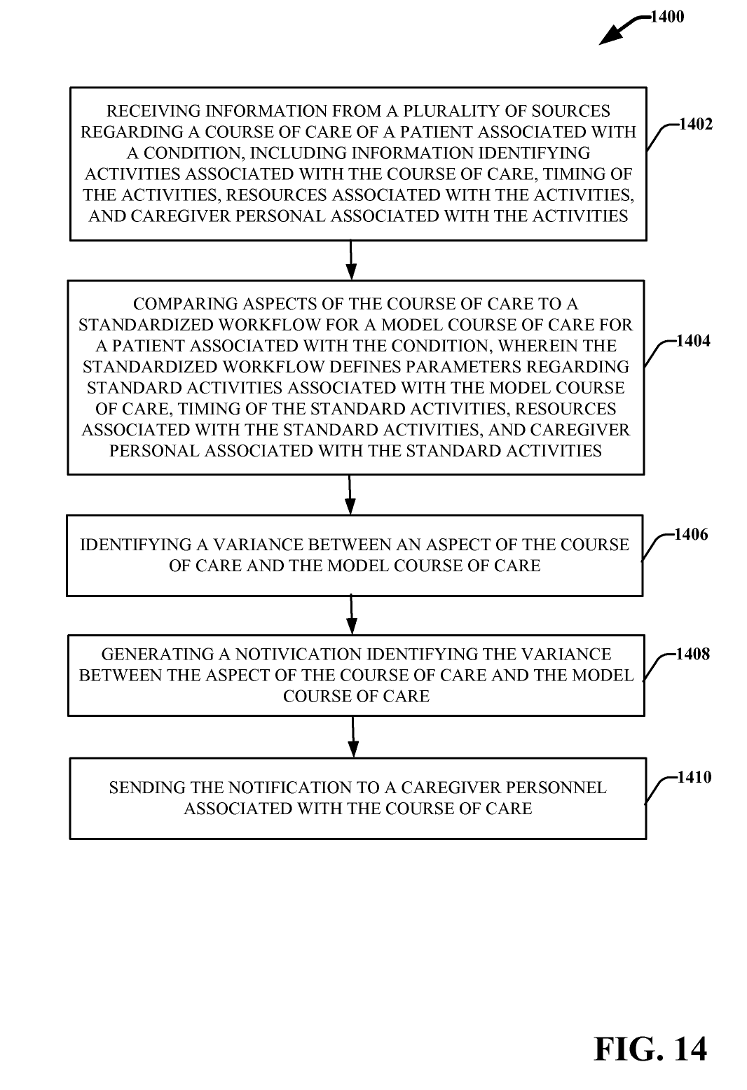

FIG. 14 illustrates a flow chart of another example method 1300 that facilitates extraction and analysis of patient encounters from one or more healthcare related information systems in accordance with various aspects and embodiments described herein. At 1402, information is received from a plurality of sources regarding a course of care of a patient associated with a condition, including information identifying activities associated with the course of care, timing of the activities, resources associated with the activities, and caregiver personal associated with the activities (e.g., via reception component 104). In particular, the information can be received in real-time during the course of care (e.g., as an activity is performed information about the activity can be received). At 1404, aspects of the course of care are compared to a standardized workflow for a model course of care for a patient associated with the condition, wherein the standardized workflow defines parameters regarding standard activities associated with the model course of care, timing of the standard activities, resources associated with the standard activities, and caregiver personal associated with the standard activities (e.g., via monitoring component 602). At 1406, a variance between an aspect of the course of care and the model course of care is identified (e.g., via analysis component 110 or monitoring component 602). At 1408, a notification identifying the variance between the aspect of the course of care and the model course of care is generated and at 1410, the notification is sent to caregiver personnel associated with the course of care (e.g., via notification component 604).

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

With reference to FIG. 15, a suitable environment 1500 for implementing various aspects of the claimed subject matter includes a computer 1502. The computer 1502 includes a processing unit 1504, a system memory 1506, a codec 1505, and a system bus 1508. The system bus 1508 couples system components including, but not limited to, the system memory 1506 to the processing unit 1504. The processing unit 1504 can be any of various available processors. Dual microprocessors and other multiprocessor architectures also can be employed as the processing unit 1504.

The system bus 1508 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13154), and Small Computer Systems Interface (SCSI).

The system memory 1506 includes volatile memory 1510 and non-volatile memory 1512. The basic input/output system (BIOS), containing the basic routines to transfer information between elements within the computer 1502, such as during start-up, is stored in non-volatile memory 1512. In addition, according to present innovations, codec 1505 may include at least one of an encoder or decoder, wherein the at least one of an encoder or decoder may consist of hardware, a combination of hardware and software, or software. Although, codec 1505 is depicted as a separate component, codec 1505 may be contained within non-volatile memory 1512. By way of illustration, and not limitation, non-volatile memory 1512 can include read only memory (ROM), programmable ROM (PROM), electrically programmable ROM (EPROM), electrically erasable programmable ROM (EEPROM), or flash memory. Volatile memory 1510 includes random access memory (RAM), which acts as external cache memory. According to present aspects, the volatile memory may store the write operation retry logic (not shown in FIG. 15) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1502 may also include removable/non-removable, volatile/non-volatile computer storage medium. FIG. 15 illustrates, for example, disk storage 1514. Disk storage 1514 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1514 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1514 to the system bus 1508, a removable or non-removable interface is typically used, such as interface 1516.

It is to be appreciated that FIG. 15 describes software that acts as an intermediary between users and the basic computer resources described in the suitable operating environment 1500. Such software includes an operating system 1518. Operating system 1518, which can be stored on disk storage 1514, acts to control and allocate resources of the computer system 1502. Applications 1520 take advantage of the management of resources by operating system 1518 through program modules 1524, and program data 1526, such as the boot/shutdown transaction table and the like, stored either in system memory 1506 or on disk storage 1514. It is to be appreciated that the claimed subject matter can be implemented with various operating systems or combinations of operating systems.

A user enters commands or information into the computer 1502 through input device(s) 1528. Input devices 1528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1504 through the system bus 1508 via interface port(s) 1530. Interface port(s) 1530 include, for example, a serial port, a parallel port, a game port, and a universal serial bus (USB). Output device(s) 1536 use some of the same type of ports as input device(s). Thus, for example, a USB port may be used to provide input to computer 1502, and to output information from computer 1502 to an output device 1536. Output adapter 1534 is provided to illustrate that there are some output devices 1536 like monitors, speakers, and printers, among other output devices 1536, which require special adapters. The output adapters 1534 include, by way of illustration and not limitation, video and sound cards that provide a means of connection between the output device 1536 and the system bus 1508. It should be noted that other devices and/or systems of devices provide both input and output capabilities such as remote computer(s) 1538.

Computer 1502 can operate in a networked environment using logical connections to one or more remote computers, such as remote computer(s) 1538. The remote computer(s) 1538 can be a personal computer, a server, a router, a network PC, a workstation, a microprocessor based appliance, a peer device, a smart phone, a tablet, or other network node, and typically includes many of the elements described relative to computer 1502. For purposes of brevity, only a memory storage device 1540 is illustrated with remote computer(s) 1538. Remote computer(s) 1538 is logically connected to computer 1502 through a network interface 1542 and then connected via communication connection(s) 1544. Network interface 1542 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1544 refers to the hardware/software employed to connect the network interface 1542 to the bus 1508. While communication connection 1544 is shown for illustrative clarity inside computer 1502, it can also be external to computer 1502. The hardware/software necessary for connection to the network interface 1542 includes, for exemplary purposes only, internal and external technologies such as, modems including regular telephone grade modems, cable modems and DSL modems, ISDN adapters, and wired and wireless Ethernet cards, hubs, and routers.

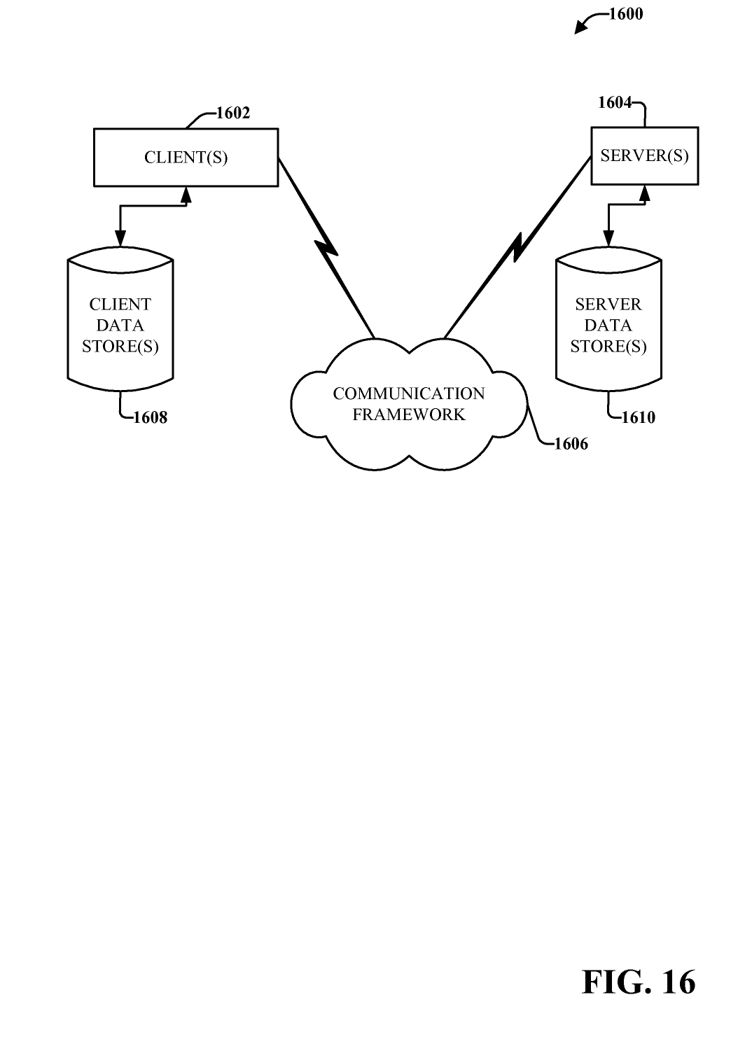

Referring now to FIG. 16, there is illustrated a schematic block diagram of a computing environment 1600 in accordance with this disclosure. The system 1600 includes one or more client(s) 1602 (e.g., laptops, smart phones, PDAs, media players, computers, portable electronic devices, tablets, and the like). The client(s) 1602 can be hardware and/or software (e.g., threads, processes, computing devices). The system 1600 also includes one or more server(s) 1604. The server(s) 1604 can also be hardware or hardware in combination with software (e.g., threads, processes, computing devices). The servers 1604 can house threads to perform transformations by employing aspects of this disclosure, for example. One possible communication between a client 1602 and a server 1604 can be in the form of a data packet transmitted between two or more computer processes wherein the data packet may include video data. The data packet can include a metadata, e.g., associated contextual information, for example. The system 1600 includes a communication framework 1606 (e.g., a global communication network such as the Internet, or mobile network(s)) that can be employed to facilitate communications between the client(s) 1602 and the server(s) 1604.

Communications can be facilitated via a wired (including optical fiber) and/or wireless technology. The client(s) 1602 include or are operatively connected to one or more client data store(s) 1608 that can be employed to store information local to the client(s) 1602 (e.g., associated contextual information). Similarly, the server(s) 1604 are operatively include or are operatively connected to one or more server data store(s) 1610 that can be employed to store information local to the servers 1604.

In one embodiment, a client 1602 can transfer an encoded file, in accordance with the disclosed subject matter, to server 1604. Server 1604 can store the file, decode the file, or transmit the file to another client 1602. It is to be appreciated, that a client 1602 can also transfer uncompressed file to a server 1604 and server 1604 can compress the file in accordance with the disclosed subject matter. Likewise, server 1604 can encode video information and transmit the information via communication framework 1606 to one or more clients 1602.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a memory that stores computer executable components;
a processor that executes at least the following computer executable components stored in the memory:
a reception component configured to receive information from a plurality of sources regarding courses of care of a plurality of patients, including information identifying activities associated with the courses of care, timing of the activities, resources associated with the activities, and caregiver personal associated with the activities;
an indexing component configured to generate an index that relates aspects of the information;
a filter component configured to employ the index to identify a subset of the information related to a subset of the courses of care for patients associated with a similar medical condition; and
an analysis component configured to compare aspects of the subset of the information to identify variance in the subset of the courses of care.

2. The system of claim 1, wherein the analysis component is configured to compare activities associated with the subset of the courses of care to identify the variance.

3. The system of claim 2, wherein the analysis component is configured to compare timing of the activities associated with the subset of the courses of care to identify the variance.

4. The system of claim 2, wherein the analysis component is configured to compare resources associated with the activities associated with the subset of the courses of care to identify the variance.

5. The system of claim 2, wherein the analysis component is configured to compare caregiver personal associated with the activities associated with the subset of the courses of care to identify the variance.

6. The system of claim 1, wherein the analysis component is configured to determine or infer a cause of the variance.

7. The system of claim 1, further comprising an optimization component configured to determine a modification to a future course of care of a patient associated with the condition based on the analysis, wherein the modification relates to at least one of, an activity associated with the course of care, a timing of the activity, a resource associated with the activity, or caregiver personal associated with the activity.

8. The system of claim 1, further comprising a standardization component configured to determine a standardized workflow for a model course of care of a patient associated with the condition based on the analysis, wherein the standardized workflow defines parameters regarding standard activities associated with the model course of care, timing of the standard activities, resources associated with the standard activities, and caregiver personal associated with the standard activities.

9. The system of claim 8, further comprising a monitoring component configured to track reception of new information regarding a new course of care of a patient associated the condition and compare the new information with the standardized workflow to identify variance between the new course of care and the model course of care.

10. The system of claim 9, further comprising a notification component configured to generate and send a notification in response to identification of a variance between the new course of care and the model course of care.

11. The system of claim 10, wherein the variance between the new course of care and the model course of care is identified during the new course of care and prior to completion of the new course of care, the system further comprising an optimization component configured to determine a mechanism to rectify the variance prior to completion of the new course of care, and wherein the notification component is configured to identify the mechanism in the notification and generate and send the notification prior to the completion of the new course of care.

12. The system of claim 1, wherein the information which the reception component is configured to receive from the plurality of sources regarding the courses of care of the plurality of patients, further includes cost information identifying costs associated with the courses of care, wherein the an analysis component is configured to compare costs respectively associated with the subsets of the courses of care to identify variance in the costs associated with the subsets of the courses

13. The system of claim 12, wherein the analysis component is further configured to compare the aspects of the subset of the information as a function of the costs respectively associated with the subsets of the courses of care to determine or infer one or more causes of the variance in the costs associated with the subsets of the courses of care.

14. The system of claim 13, wherein the aspects pertain to activities associated with the subset of the courses of care, timing of the activities associated with the subset of the courses of care, resources associated with the activities associated with the subset of the courses of care, and caregiver personal associated with the activities associated with the subset of the courses of care.

15. The system of claim 13, further comprising an optimization component configured to determine a modification to a future course of care of a patient associated with the condition based on the based on the one more causes of the variance in the costs associated with the subsets of the courses of care, wherein the modification relates to at least one of, an activity associated with the course of care, a timing of the activity, a resource associated with the activity, or caregiver personal associated with the activity.

16. The system of claim 13, further comprising a standardization component configured to determine a standardized workflow for a model course of care of a patient associated with the condition based on the analysis, wherein the standardized workflow includes parameters defining standardized costs associated with the model course of the care determined based on the one more causes of the variance in the costs associated with the subsets of the courses of care.

17. A method comprising:
using a processor to execute the following computer executable instructions stored in a memory to perform the following acts:
receiving information from a plurality of sources regarding courses of care of a plurality of patients, including information identifying activities associated with the courses of care, timing of the activities, resources associated with the activities, and caregiver personal associated with the activities;
generating an index that establishes relationships between aspects of the information;
employing the index to identify a subset of the information related to a subset of the courses of care for patients associated with a similar medical condition; and
comparing aspects of courses of care included in the subset to identify variance between the courses of care included in the subset.

18. The method of claim 17, wherein the comparing comprises comparing the aspects of the courses of care included in the subset to identify variance in at least one of: quality, efficiency, cost, or outcome, between the courses of care included in the subset with.

19. The method of claim 17, wherein the comparing comprises at least one of:
comparing activities associated with the courses of care included in the subset,
comparing timing of the activities associated with the courses of care included in the subset,
resources associated with the activities associated with the courses of care included in the subset, or
comparing caregiver personal associated with the activities associated with the courses of care included in the subset.

20. The method of claim 17, further comprising, determining or inferring a cause of the variance based on the comparing.

21. The method of claim 17, further comprising, determining a modification to a future course of care of a patient associated with the condition based on the analysis, wherein the modification relates to at least one of, an activity associated with the course of care, a timing of the activity, a resource associated with the activity, or caregiver personal associated with the activity.

22. The method of claim 17, further comprising, determining a standardized workflow for a model course of care of a patient associated with the condition based on the analysis, wherein the standardized workflow defines parameters regarding standard activities associated with the model course of care, timing of the standard activities, resources associated with the standard activities, and caregiver personal associated with the standard activities.

23. The method of claim 22, further comprising:
tracking reception of new information regarding a new course of care of a patient associated the condition; and
comparing the new information with the standardized workflow to identify variance between the new course of care and the model course of care.

24. The method of claim 23, further comprising, generating and sending a notification in response to identification of a variance between the new course of care and the model course of care.

25. The method of claim 24, further comprising:
identifying the variance between the new course of care and the model course of care during performance of the new course of care and prior to completion of the new course of care;
determining a mechanism to rectify the variance prior to completion of the new course of care; and
generating and sending the notification prior to the completion of the new course of care, wherein the notification identifies the mechanism.

26. A tangible computer-readable storage medium comprising computer-readable instructions that, in response to execution, cause a computing system to perform operations, comprising:
receiving information from a plurality of sources regarding courses of care of a plurality of patients, including information identifying activities associated with the courses of care, timing of the activities, resources associated with the activities, and costs associated with the activities;
generating an index that establishes relationships between aspects of the information;
employing the index to identify a subset of the information related to a subset of the courses of care for patients associated with a similar medical condition; and
comparing aspects of courses of care included in the subset to identify variance between the courses of care included in the subset.
